(19) United States
(12) Patent Application Publication
(10) Pub. No.: US 2002/0004760 A1
(43) Pub. Date: Jan. 10, 2002

(54) Online settlement system, method thereof and storage medium

(76) Inventors: Toshio Yoshida, Tokyo (JP); Mitsuhiro Komura, Tokyo (JP); Akira Yamashita, Tokyo (JP); Atsushi Izuka, Tokyo (JP); Toru Mizuki, Tokyo (JP); Shusuke Kita, Tokyo (JP); Masanori Kubo, Kawasaki (JP); Isao Yagasaki, Kawasaki (JP); Toshimitsu Kuroda, Kawasaki (JP)

Correspondence Address: STAAS & HALSEY LLP, 700 11TH STREET, NW, SUITE 500, WASHINGTON, DC, 20001, US

(21) Appl. No.: 09/873,361

(22) Filed: Jun. 5, 2001

(30) Foreign Application Priority Data
Jun. 5, 2000 (JP) 2000-167174

(51) Int. Cl. G06F 17/60

(52) U.S. Cl. 705/26

(57) ABSTRACT

When a user does shopping on a commodity purchase screen provided by a shop via the Internet, the user uses a payment reservation service provided by a claim management server. Then, the claim management server stores the shopping content of the user as a database and simultaneously stores both a payment amount and a settled/unsettled payment status in the shopping contents. The user views the list of unsettled payment of the shopping content provided by the claim management server, selects a shopping item, the price payment of which the user is going to settle, designates an account handling institute to use and settles payment online. The claim management server automatically does the check work of the shopping content, the price payment of which is settled.

### BACKGROUND OF THE INVENTION

1. Field of the Invention

The present invention relates to an online settlement system via a network.

2. Description of the Related Art

Today, the Internet is popular and a variety of services are provided on the network. Especially, a service by which a commodity is purchased on the Internet, the price is paid and the commodity is delivered, is expected to be popular. If such a service become more popular, a method for paying the price of a commodity when a user purchases a commodity via a network must be more convenient and secure.

FIG. 1 shows the conventional process in the case where the price of a commodity is paid by bank account settlement via the Internet.

A user 10 views a homepage, etc., provided by a shop 12 and applies for the purchase of a commodity. Then, the shop 12 lastly displays a screen for asking how to pay the price of the commodity on the user's screen. The purchase application of a commodity is usually completed by the determination of this payment method. In this case, it is assumed, for example, that the user 10 orders a commodity by selecting bank account settlement. Then, the bank names, branch names, account numbers, etc., that are available for the shop 12 are displayed on the browser screen of the user 10. The user 10 is requested to pay the price of the commodity to one of the accounts displayed on this browser screen later.

Although the user 10 can actually visit the branch of a bank 13 with this account and can pay the price, in the case of shopping on the Internet 11, the branch of the bank 13 with the account, to which the price is requested to be paid often is located geographically far away from the home of the user 10. Therefore, the user 10 uses a bank payment service via the Internet 11 provided by the relevant bank 13.

In this way, the user 10 accesses the relevant bank 13 via the Internet 11 again and displays the online payment screen of the bank 13. In this case, the user is required to input the name of a payment receiver, the account number, an amount to be paid, etc., as in the case of regular bank account payment. At this moment, the user 10 memorizes the price of the commodity purchased from the shop 12 online and pays the amount from his/her own account. However, if the user 10 purchases many commodities or the payment is made a long time later, it is difficult for the user 10 to remember the price, and the burden of the user 10 becomes heavy even if the price is written down on a piece of paper. Therefore, there is a possibility that the price of a commodity may not be correctly paid.

If the shop 12 wants that the user 10 correctly pays the price of a commodity, the shop 12 must manage the sales proceeds of all the users that purchase commodities via the Internet 11. Therefore, the workload of the shop 12 becomes also heavy.

Furthermore, if the user 10 wants to pay to the account of the shop 12 from his/her own account, the online payment is refused when the balance of his/her own account is equal to or more than the price of the commodity. In this case, the user 10 wants to pay the price only after a sufficient amount of money is stored in his/her account, and it often takes much time. Therefore, in this case, there is also a possibility that the payment of the price of the commodity may be delayed.

Therefore, the “check work” of the shop 12, for checking whether the price of each sold commodity is correctly paid becomes very troublesome. If the bank 13 does the “check work” instead of the shop 12, the workload is simply shifted from the shop 12 to the bank 13 and the bank 12 must check whether the price is correctly paid. In this case, the total workload even increases.

As described above, if the price of a commodity is paid to a bank account on line, the user 10 is requested to perform a troublesome payment process.

The user 10 must memorize a payment process. If a plurality of shopping items are left unpaid, the memorization of such payment becomes more troublesome since each payment is different in the amount and payment time limit. In the actual settlement, the input work of the name of a payment receiver, a payment amount also becomes troublesome.

If transactions fail due to such a problem of a user 10, the sales of an online shop 12 are influenced. The “check work” of the payment by bank account settlement is also usually troublesome.

If an account handling institute (bank 13) conventionally does “check work” instead of a shop 12, a virtual account is provided for each order and the amount is paid to the account. According to this method, the number of accounts must be temporarily increased and workload is added to the resources of the account handling institute. Furthermore, the institute must provide the result of the “check work” to the shop 12.

### SUMMARY OF THE INVENTION

It is an object of the present invention to provide a system in which a user can accurately and easily pay the price of a commodity in online shopping.

The online settlement system of the present invention is an online settlement system for settling transaction payment online. The system comprises a transaction content storage unit storing the transaction content of a user, an unsettled payment list display unit displaying unsettled ones of the transaction contents stored in the transaction content storage unit at a request of the user and a payment unit enabling the user to pay the price of a transaction content to be settled by the user to an account handling institute.

The online payment method of the present invention is an online payment method for settling transaction payment online. The method comprises storing the transaction contents of a user, displaying unsettled ones of the transaction contents stored in the transaction content storing step at a request of the user and enabling the user to pay the price of a transaction content to be settled by the user to an account handling institute.

According to the present invention, the online settlement system can store both the online and offline transaction contents agreed by the user and can present the contents to the user as requested. Therefore, a user can save workload required to manage transaction histories, such as shopping, etc.

As a result, the payment of a transaction price can be prevented from being forgotten, and payment for online shopping, etc., can be more accurately made. A shop can also save workload for managing the histories of both online and offline shopping done at his/her shop.

### BRIEF DESCRIPTIONS OF THE DRAWINGS

FIG. 1 shows the conventional process in the case where the price of a commodity is paid by bank account settlement via the Internet.

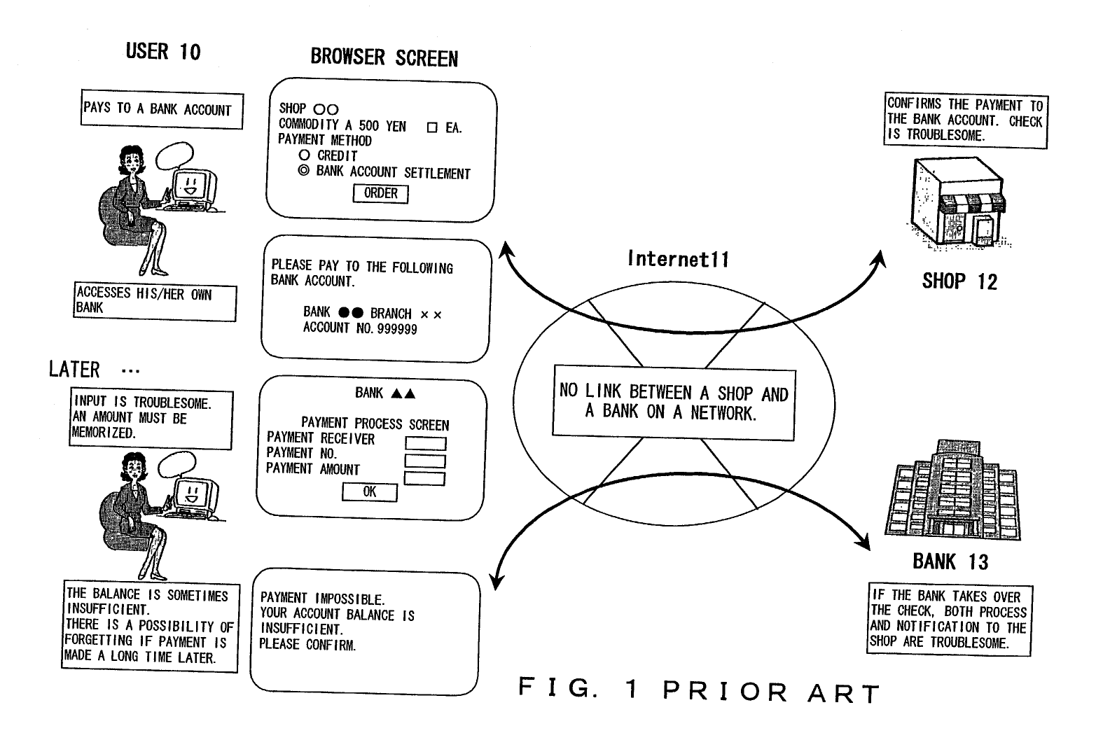

FIG. 2 shows the concept of the process in the preferred embodiment of the present invention.

FIG. 3 is a sequence chart showing the process flow in the preferred embodiment of the present invention in the case where there are a plurality of account handling institutes (No. 1).

FIG. 4 is a sequence chart showing the process flow in the preferred embodiment of the present invention in the case where there area plurality of account handling institutes (No. 2).

FIG. 5 is a sequence chart showing the process flow in the preferred embodiment of the present invention in the case where there are a plurality of account handling institutes (No. 3).

FIG. 6 is a sequence chart showing the process flow in the preferred embodiment of the present invention in the case where there are a plurality of account handling institutes (No. 4).

FIG. 7 is a sequence chart showing the process flow in the preferred embodiment of the present invention in the case where there are a plurality of account handling institutes (No. 5).

FIG. 8 is a sequence chart showing the process flow in the preferred embodiment of the present invention in the case where there are a plurality of account handling institutes (No. 6).

FIG. 9 is a sequence chart showing the process flow in the preferred embodiment of the present invention in the case where there are a plurality of account handling institutes (No. 7).

FIG. 10 is a flowchart showing the order reception process of the preferred embodiment.

FIG. 11 is a flowchart showing the unsettled payment list display process.

FIG. 12 is a flowchart showing a process ranging from the selection of a payer account till the payment (No. 1).

FIG. 13 is a flowchart showing a process ranging from the selection of a payer account till the payment (No. 2).

FIG. 14 is a flowchart showing a process of recommending an account to be used to a user.

FIG. 15 is a flowchart showing a process of grouping a plurality of orders to be settled (No. 1).

FIG. 16 is a flowchart showing a process of grouping the plurality of orders to be settled of the same payer/payment receiver (No. 2).

FIG. 17 is a flowchart showing a process of transmitting a warning message to both a shop and a user when overdue orders are deleted.

FIG. 18 is a flowchart showing a process of putting a related advertisement on the unsettled payment list display screen.

FIG. 19 is a flowchart showing the process in the case where a shop makes an inquiry on the order status to a claim management server.

FIG. 20 shows one display of the unsettled payment selection screen of the unsettled payment list screen.

FIG. 21 shows one display of the order/account setting screen of the unsettled payment list screen.

FIG. 22 shows one display of the order list screen displayed when a shop makes an inquiry on the order status to the claim management server.

FIGS. 23A through 23D show one construction of each table (No. 1).

FIGS. 24A and 24B show one construction of each table (No. 2).

FIG. 25 is a sequence chart showing the flow of a purchase order reception process in the case of later payment in another preferred embodiment of the present invention (No. 1).

FIG. 26 is a sequence chart showing the flow of a purchase order reception process in the case of later payment in another preferred embodiment of the present invention (No. 2).

FIG. 27 is a sequence chart showing the flow of the shopping settlement process in the case of later payment in another preferred embodiment (No. 1).

FIG. 28 is a sequence chart showing the flow of the shopping settlement process in the case of later payment in another preferred embodiment (No. 2).

FIG. 29 is a sequence chart showing the flow of the process in the case of shopping spot payment in another preferred embodiment (No. 1).

FIG. 30 is a sequence chart showing a process flow in the case of shopping spot payment in another preferred embodiment (No. 2).

FIG. 31 is a sequence chart showing a process flow in the case of shopping spot payment in another preferred embodiment (No. 3).

FIG. 32 is a flowchart showing the order reception process in another preferred embodiment.

FIG. 33 is a flowchart showing the unsettled payment list display process in another preferred embodiment.

FIG. 34 is a flowchart showing the payment process in another preferred embodiment.

FIG. 35 shows a general hardware configuration required for the claim management server or the server of an account handling institute (bank) in each preferred embodiment.

### DESCRIPTIONS OF THE PREFERRED EMBODIMENTS

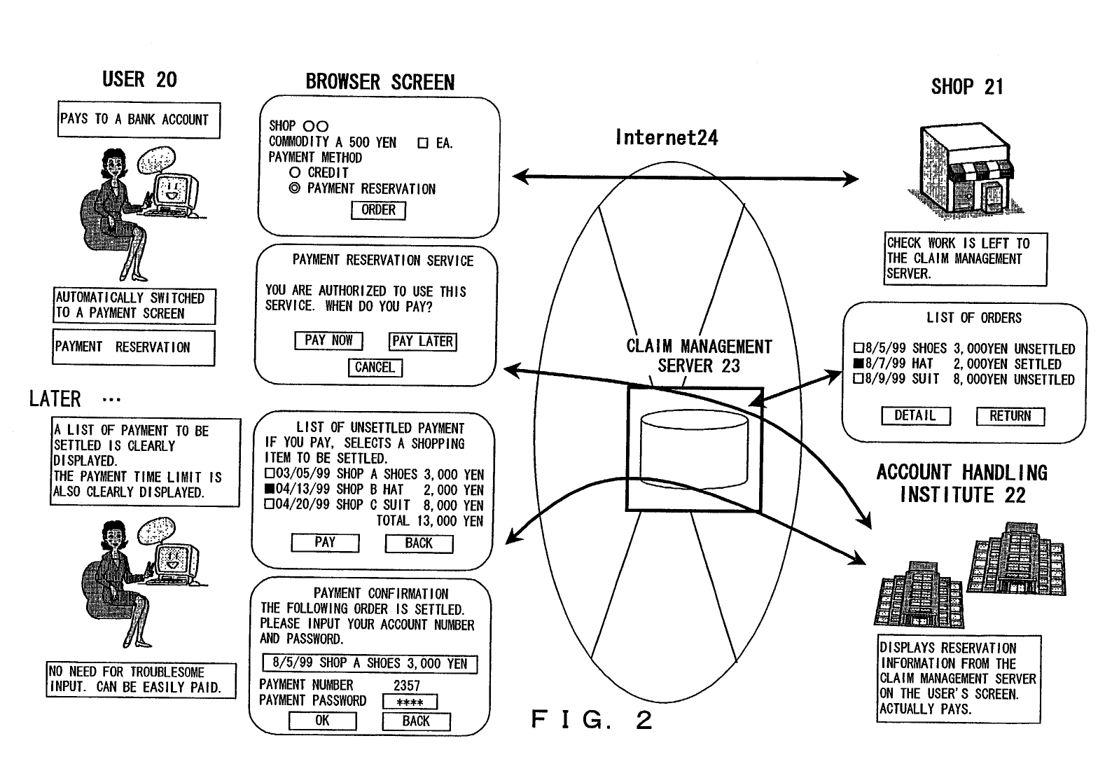

FIG. 2 shows the concept of the process in the preferred embodiment of the present invention.

The preferred embodiment of the present invention comprises a claim management server 23 linking a shop 21 with a bank (account handling institute 22) in a network (the Internet 24). If a user selects “bank account settlement” on the purchase order screen of the shop 21, the claim management server 23 stores commodity information, amount/user information, shop's payment time limit, etc.

The claim management server 23 displays a list of data about shopping items to be settled, makes the user select a shopping item, guides the user to a bank screen and makes the user settle the shopping item. Sometimes the list of shopping items to be settled is provided to the server of an account handling institute 22, and the account handling institute 22 displays the list.

On receipt of information/data about payment from the account handling institute, the claim management server 23 makes an inquiry on the possibility of the bank account settlement of shopping items to the shop 21 and also provides the settled/unsettled status of each shopping item to the shop 21. The user can also refer to shopping items, the payment of which are settled for a specific time period.

As the application services of the preferred embodiment of the present invention there are the settlement of EC (e-commerce), the payment of public utility charges (in the case of individual payment), etc. Account handling institutes 22 that provide such services in cooperation with the claim management server 23 are financial institutes handling accounts, such as a bank, a post office, a stock company, an insurance company, etc.

The summary of the process flow of the preferred embodiment is described with reference to FIG. 2.

First, if a user 20 purchases a commodity in a shop 21 via the Internet 24, on the browser screen of the homepage of the shop 21, data about the purchased commodity is displayed and the payment method is asked. If the user 20 selects “payment reservation”, the screen is switched to the screen of the payment reservation service of the claim management server 23. At this moment the user 20 can be authorized to use the claim management server 23 by inputting his/her ID number and password, etc. On the payment reservation service screen, it is asked whether the payment is made now or later. If the user settles later, the user gets out of the service of the claim management server 23.

In that case, the user 20 is requested to access the claim management server 23 later again, to be authorized to use the payment reservation service and to display the menu screen of the payment reservation service. On the menu screen, there are selection items required by the relevant system, such as “account registration/modification”, “unsettled payment list/payment”, “settled payment list”, etc. If “unsettled payment list/payment” is selected on this menu screen, the list of unsettled purchase orders, specifically, the description of each purchased commodity, the name of a shop 21, the date of purchase, the purchase amount, etc., are displayed on the browser screen of the user 20.

The user 20 selects a commodity, the price of which is to be paid by him/her, from the list. Then, the claim management server 23 displays the order information of the commodity selected to be paid, such as the amount, commodity details, etc. If the user 20 expresses his/her intention to settle, the claim management server 23 transmits the data to an account handling institute 22, the list of commodities to be settled by a bank account is displayed on the payment confirmation screen and also the input of a payment number, a payment password, a bank account number, etc., is requested in order to settle the payment. If the user 20 inputs the data, the payment is settled.

In this case, it is preferable for the claim management server 23 to be configured to automatically check the payment by providing each claim with both an invoice number and payment time limit. If the shop 21 is subscribed to the service of the claim management server 23, the shop 21 can view the list of the purchase orders to his/her own shop and can also obtain the list of the descriptions of settled/unsettled commodities as the check result of the claim management server 23. According to the preferred embodiment described above, by accessing the claim management server 23, the user 20 can easily obtain the histories of online shopping and can easily settle the payment of an unsettled commodity without checking all the histories of his/her online shopping by himself/herself.

Since the claim management server 23 can automatically do check work, it is acceptable for the account handling institute 22 performs only the payment process of the price, and the shop 21 can easily obtain the list of the unsettled payment of commodities. In this way, the processes of both the shop 21 and account handling institute 22 can be greatly simplified.

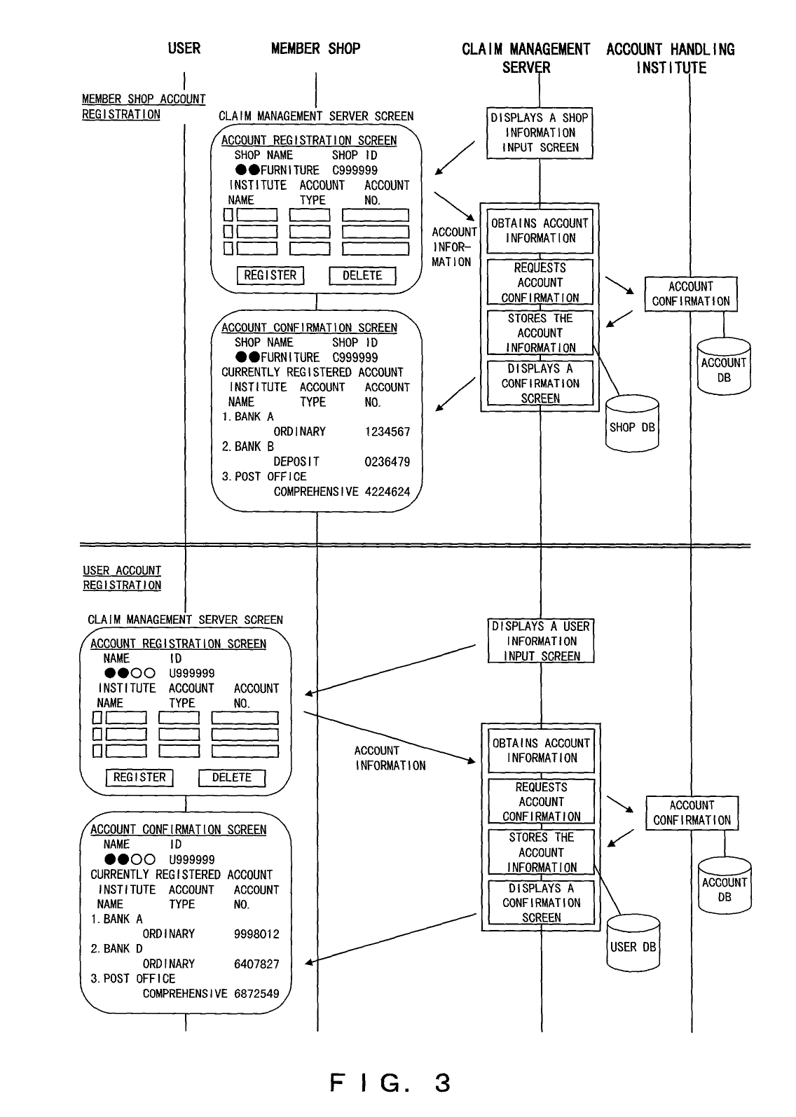

FIGS. 3 through 9 are sequence charts showing the process flow of the preferred embodiment of the present invention in the case of where a plurality of account handling institutes are used.

FIGS. 3 through 5 are sequence charts showing the process flow of the account registration in a claim management server of both a member shop and a user.

When the member shop of the service of a claim management server registers an account in the claim management server, first the member shop accesses the claim management server and makes the claim management server display a shop information input screen. Then, on the claim management server screen of the member shop, an account registration screen is displayed. Then, the input/selection screen of the name of an account handling institute to be registered, the type of an account, an account number as well as the name of the member shop and the shop ID is displayed. The member shop inputs/selects necessary items and pushes a registration button.

In this way, the claim management server obtains the account information of the member shop and issues a request to confirm the existence of an account to an account handling institute. The account handling institute accesses the account database storing account information, checks whether there is actually the account inquired from the claim management server and notifies the claim management server of the result. If there is actually the account, the claim management server stores the account information in the shop database and displays a screen indicating that the account registration is completed on the claim management server screen of the member shop.

Then, the account registration process is terminated.

The account registration of a user is the same as that of the member shop. A user subscribed to the service of the claim management server accesses the claim management server and makes the claim management server display a user information input screen. On the account registration screen, the input/selection screen of the name of a bank to be registered, the type of account and an account number as well as the name of the user and the user ID, is displayed. The user inputs/selects information about an account that is he/she is going to use and pushes a registration button. Then, the account information is transferred to the claim management server. The claim management server obtains the account information and issues an account confirmation request to the account handling institute included in the account information. The account handling institute retrieves data from account database storing account information and notifies the claim management server of the existence/non-existence of the account. If there is the account, the claim management server stores the account information in the user database and displays a confirmation screen for indicating that the account registration is completed. The user confirms the registered account on the account confirmation screen transmitted from the claim management server and terminates the process.

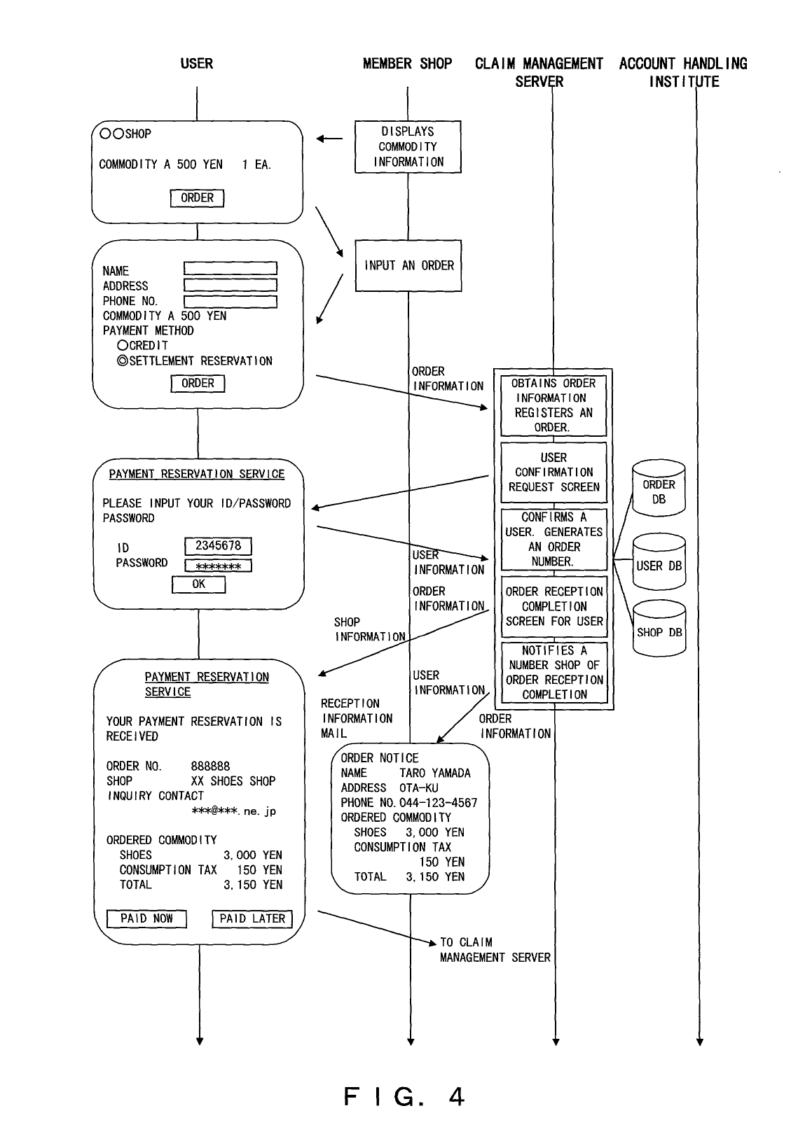

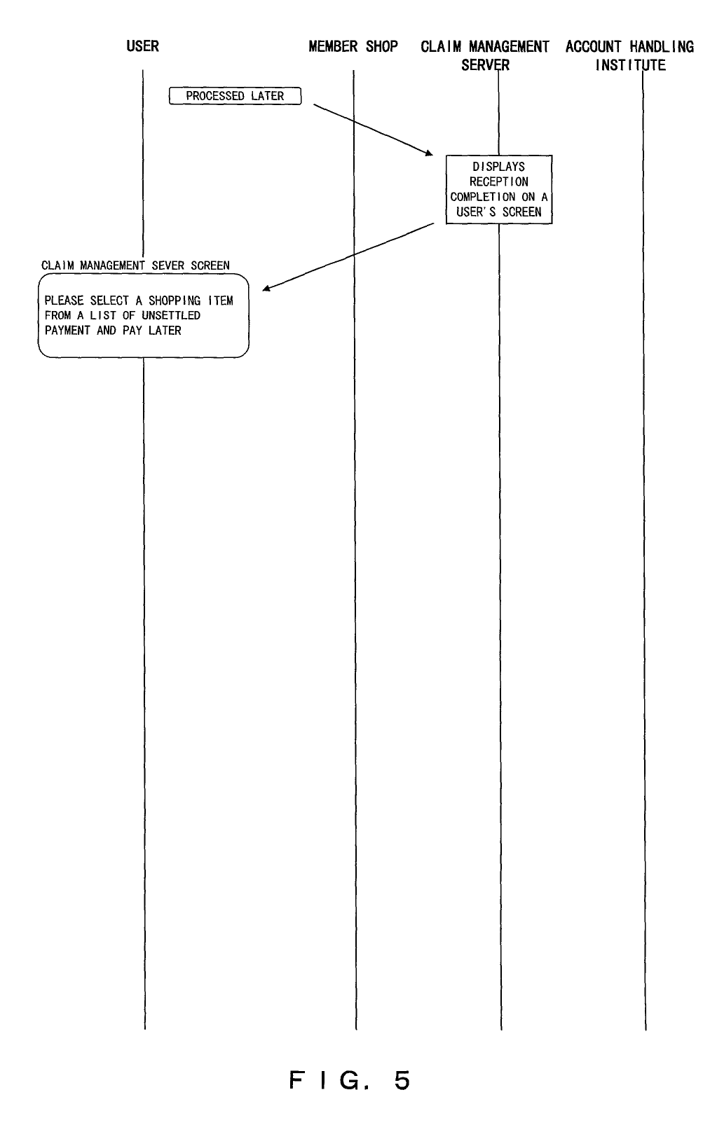

FIGS. 4 and 5 are sequence charts showing the process flow in the case where the claim management server receives a purchase order with later payment.

First, a member shop displays commodities to be sold on the Internet on a homepage, etc. A user views this homepage and places a purchase order for a commodity with the member shop. On receipt of the purchase order for the commodity from the user, the server of the member shop displays a screen for a user to input user information. This screen includes the input designation of the description of an ordered commodity, the price and the payment method in addition to the name, address and phone number of a user.

If on the user information input screen, the user inputs necessary items and selects “payment reservation” as a payment method, the order information is transferred to the claim management server.

The claim management server obtains the order information and registers the order. Then, the server presents to the user a confirmation request screen to judge whether the user is authorized to use the claim management server and authorizing the user. On the confirmation request screen, the user inputs his/her own ID and password, and transfers the information to the claim management server. On receipt of the user information, the claim management server retrieves data from the user database and judges whether the user is a regular registration user. If the user is a regular user, the server attaches an order number to the order and registers the order in an order database.

If the order is registered, an order reception completion screen is displayed on the user's screen. At this moment, shop information obtained from a shop database is displayed together with the content of the order. As for the member shop, an order reception completion notice is transmitted to confirm that the claim management server has received the order from the user. At this moment, the user information is obtained from the user database and is included in the order reception completion notice.

On the order reception completion screen of the user, it is requested to input whether a payment reservation is made. If the user selects later payment, the information is transferred to the claim management server and the reception completion is displayed on the user's screen. In this reception completion display, the reminder of later payment is displayed on the user's screen.

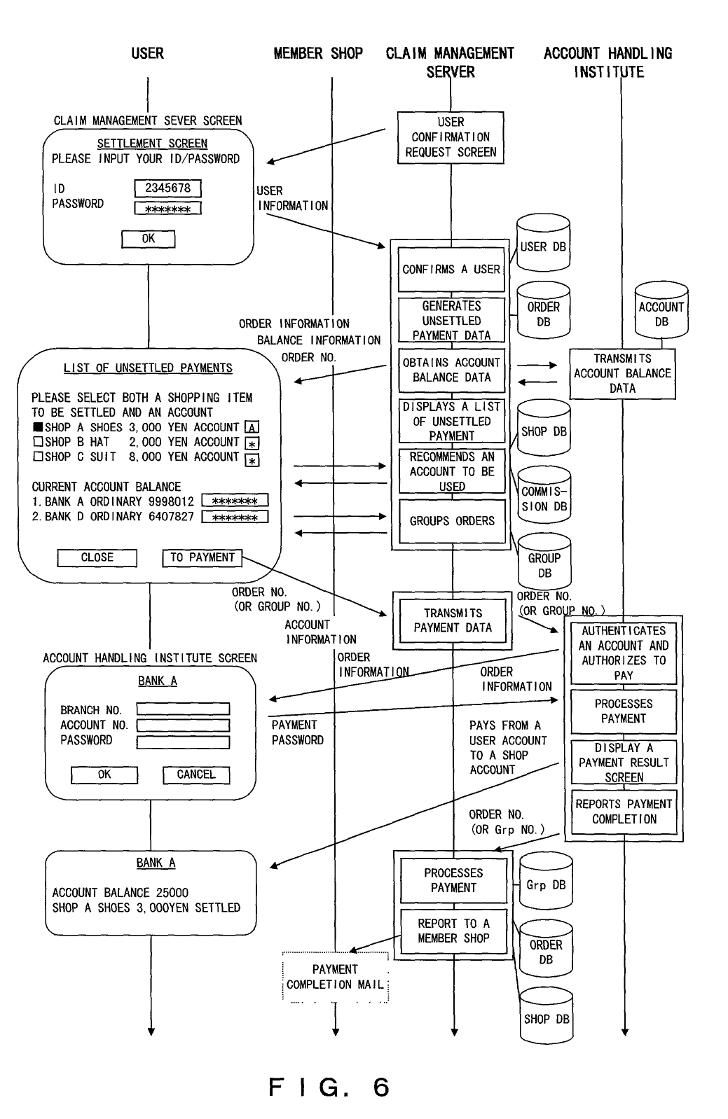

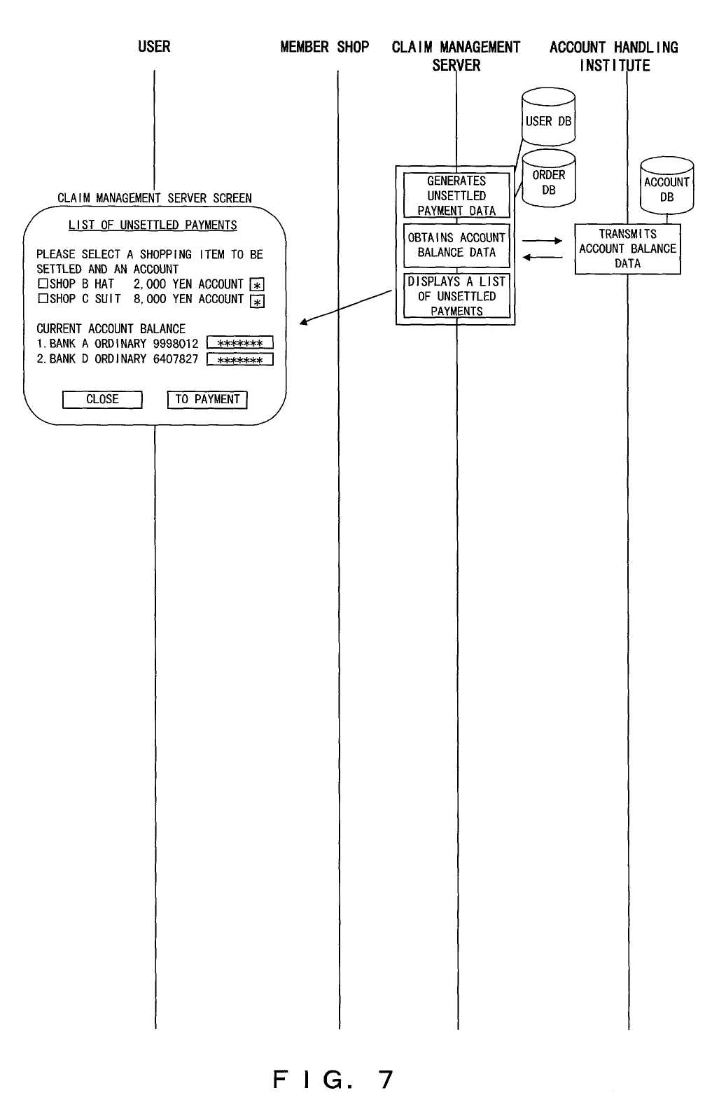

FIGS. 6 and 7 are sequence charts showing the flow of the settlement process in the case of later payment.

If a user accesses a claim management server in order to make settlement, the claim management server displays a user confirmation request screen. The user inputs his/her own ID and password according to the instructions displayed on this screen. This user information is transmitted to the claim management server and is compared with the content of a user database. If as a result, the user is judged to be an authenticated user, the claim management server retrieves data from an order database and generates unsettlement data. Furthermore, the claim management server accesses an account handling institute and requests the institute to obtain the balance data of the account that the user is going to use. The account handling institute refers to an account database and transmits the account balance data to the claim management server.

The claim management server generates a list of unsettled payment based on both the unsettled payment data and account balance data, and displays the list of unsettled payment on the user's screen. If the user designates payment on the list of unsettled payment, this information is transferred to the claim management server, and services of recommending an account to be used (account utilization recommendation), grouping orders, etc., which are described later, are provided. Such services are provided by retrieving data from a shop database, a commission database, a group database, which are described later.

If the user inputs or selects a shopping item and designates “payment”, the order number or group number in the case of grouped orders, account information and order information are transferred to the claim management server. On receipt of such information, the claim management server transmits the payment data to the account handling institute.

On receipt of the payment data, the account handling institute requests the user to input a branch number, his/her account number, his/her password, etc., in order to authorize the user to use the bank account settlement service via a network. If the user is authenticated, the payment is made from the account of the user to the account of the member shop, and the payment result screen is displayed on the user's screen. To the claim management server, a payment completion notice is reported.

On receipt of the payment completion notice, the claim management server performs a settlement process (check process), updates both the group database and order database and notifies the member shop of the payment of the price of a commodity by electronic mail.

The claim management server generates unsettled payment data by referring to both the user database and order database and requests the account handling institute to obtain account balance data. The account handling institute obtains a new account balance by referring to the account database and transfers the data to the claim management server. The claim management server generates a list of unsettled payment from both the updated unsettled payment data and account balance data, and presents the list to the user. In this way, the shopping item settled by the user is deleted from the list of unsettled payment, and the remaining unsettled shopping items and the account balance are displayed. If the user further performs a payment process, the same process as that described above is performed. If the user terminates the payment process, the user terminates the access to the claim management server without any process.

A shopping item is deleted from the list of the unsettled payment by hoisting a “settled” flag on the commodity information or deleting a “unsettled” flag. This settled commodity information is configured to be referenced by a shop or user as a payment history. Specifically, by sorting and displaying a plurality of pieces of settled commodity information for each shop and for each user, both a shop and a user can refer to past payment histories.

In this case, it is preferable that this system is configured so that both a user and a shop can display payment data, such as the commodity content of each shopping using both the list of unsettled payment and payment histories.

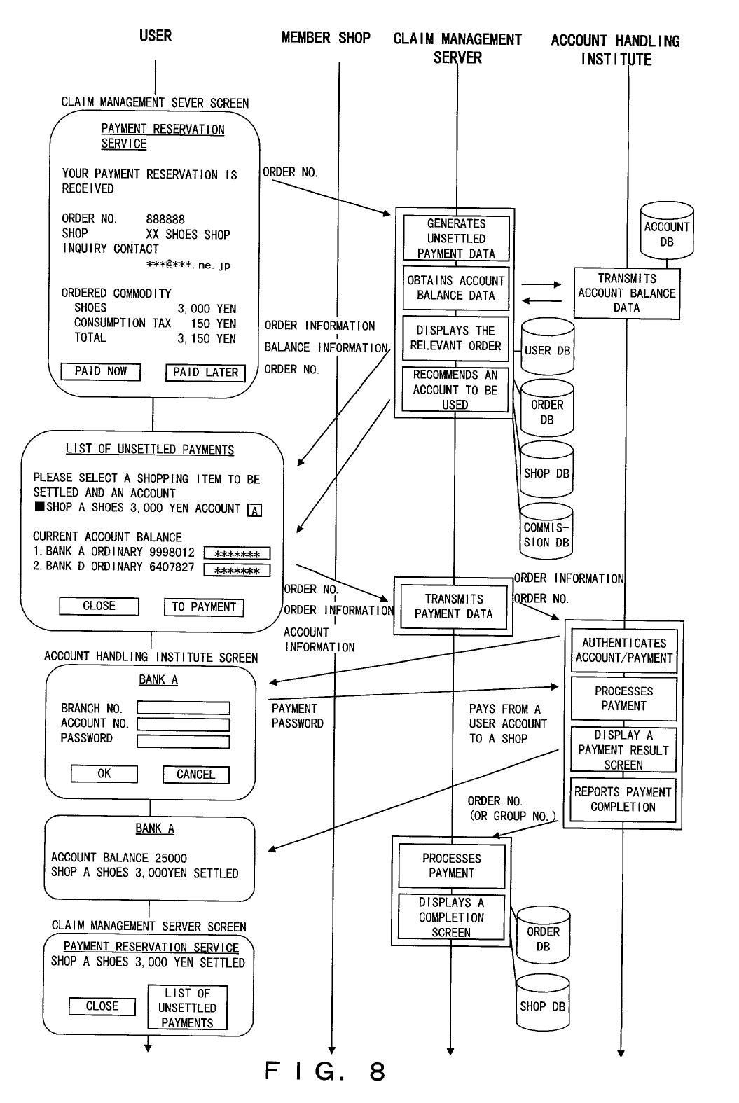

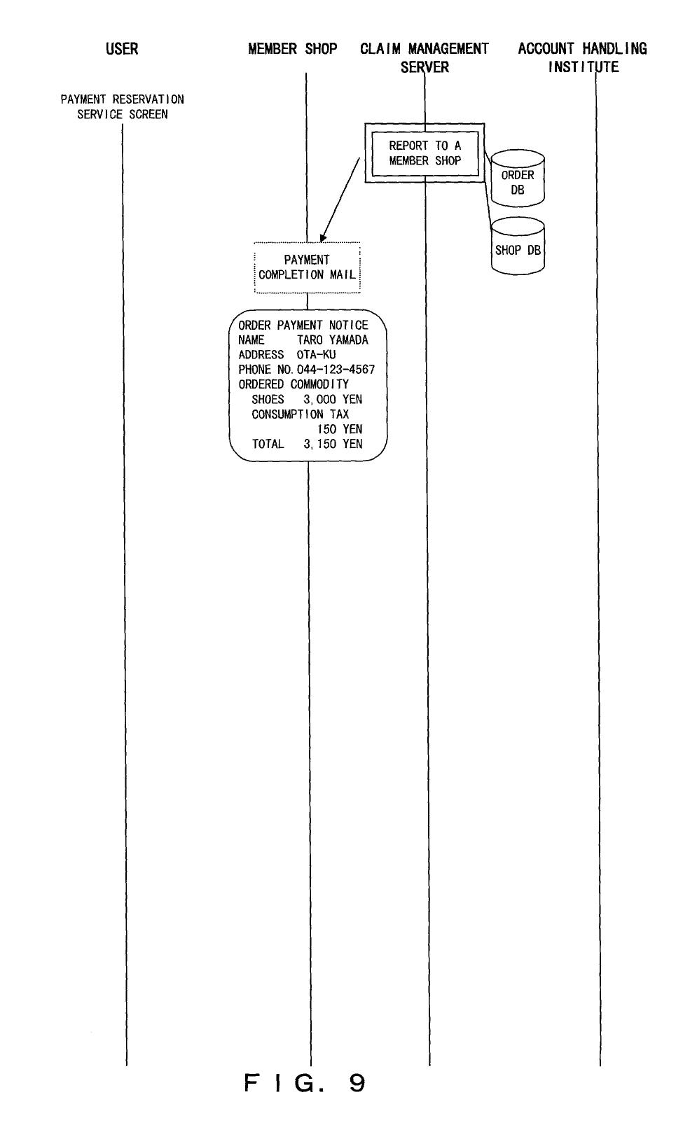

FIGS. 8 and 9 are sequence charts showing the flow of the process performed in the case where there are a plurality of account handling institutes and spot payment is made.

First, it is assumed that a user accesses a claim management server and the user selects spot payment on a payment reservation service screen. Then, the claim management server obtains an order number from the user and generates unsettled payment data. Then, the claim management server makes an inquiry about an account balance of an account handling institute. The account handling institute obtains account balance data by referring to an account database and transmits the data to the claim management server. Then, the institute displays an order to be settled by the user, and recommends an account to be used. In this case, the claim management server refers to a user database, an order database, a shop database and a commission database.

If the user side selects an account and designates payment, the account information is temporarily transmitted to the claim management server as payment data, and the account number, order information and order number are transmitted to an account handling institute with the relevant account from the claim management server. The account handling institute instructs the user to input the branch number, his/her account number and his/her password. If the user input the data and the user is authenticated by the account handling institute, a payment process is performed.

If the payment from a user account to a shop account is completed, the account handling institute displays a payment result screen on the user's screen. A payment completion is also reported to the claim management server. On receipt of the payment completion notification, the claim management server performs a settlement process (check process), updates the order database and also displays a screen for indicating the settlement completion on the user's screen. Furthermore, the claim management server notifies the member shop of the completion of the payment of the commodity price by electronic mail by referring to both the order database and shop database.

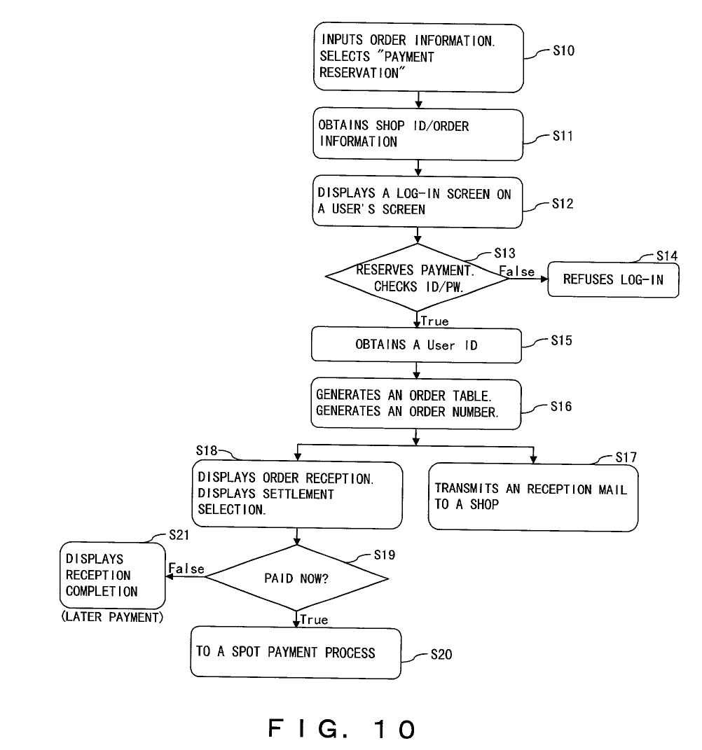

FIG. 10 is a flowchart showing the order reception process of the preferred embodiment described above.

First, in step S10, a user inputs order information and selects “payment reservation”. Then, in step S11, a claim management server obtains both a shop ID and the order information. Then, in step S12, the claim management server display the log-in screen of the service of the claim management server on the user's screen. Then, in step S13, the claim management server checks the ID and password of the user and judges whether the user should be logged in the payment reservation service. If the ID and password are not authenticated, in step S14 the log-in is refused. If the user is authenticated, in step S15 the claim management server obtains a user ID.

Then, in step S16 the claim management server generates both an order table and an order number, and in step S17 the server transmits a mail for indicating the reception of a payment reservation service to a member shop. The claim management server also displays both the reception of an order and payment selection (step S18). Then, in step S19 it is judged whether it is spot payment or later payment, based on the user's input. If it is spot payment, in step S20 the claim management server performs a spot payment process. If it is later payment, in step S21 reception completion is displayed on the user's screen.

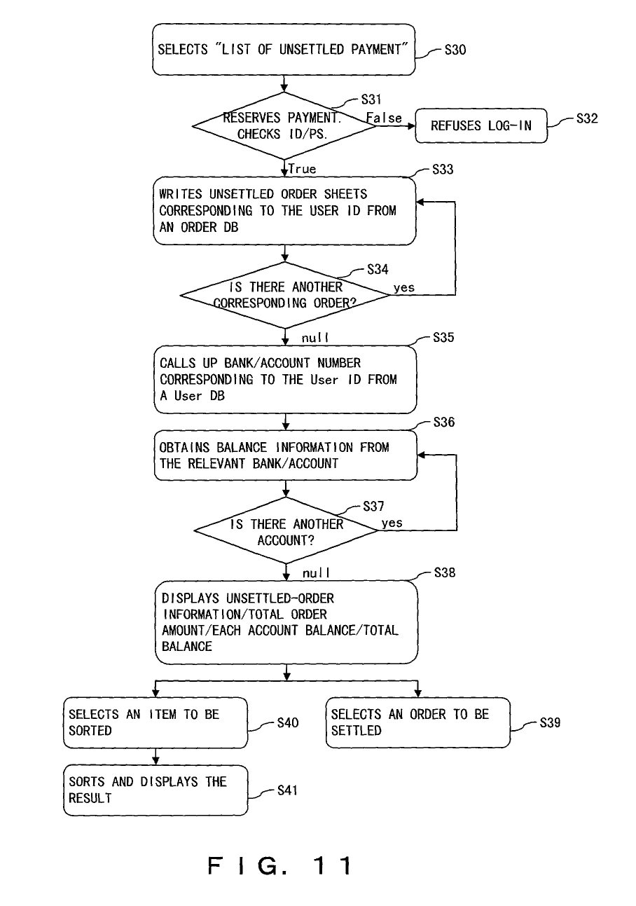

FIG. 11 is a flowchart showing the unsettled payment list display process.

First, in step S30, a user selects a shopping item from a list of unsettled payment. Then, in step S31, a log-in screen of a payment reservation service is displayed. Then, the user inputs both his/her user ID and password to this screen. If the user is not authenticated, in step S32, the log-in is refused. If the user is authenticated, the flow proceeds to S33 and unsettled orders corresponding to the user ID are written from an order database. Then, in step S34 it is judged whether there is another corresponding unsettled order. If there is such an order, the flow returns to step S33, and unsettled orders are written from the order database. If in step S34 there is not such an order, the flow proceeds to step S35.

In step S35, both bank (account handling institute)/account number corresponding to the user ID are called up from a user database. In step S36, balance information is obtained from the corresponding bank account. Then, in step S37 it is judged whether there is another account. If there is another account, the flow proceeds to step S36 and balance information is obtained from the account. If in step S36 it is judged whether there is no other account, the flow proceeds to step S38, and unsettled orders, the total amount of the unsettled orders, each account balance and the total balance are displayed on the user's screen. If the user settles payment, the flow proceeds to step S39 and the user selects an order to be settled. If the user wants to display a list of unsettled payment, the flow proceeds to step S40, and the user selects items to be sorted. In step S41, a sorting process is performed and the sorting result is displayed.

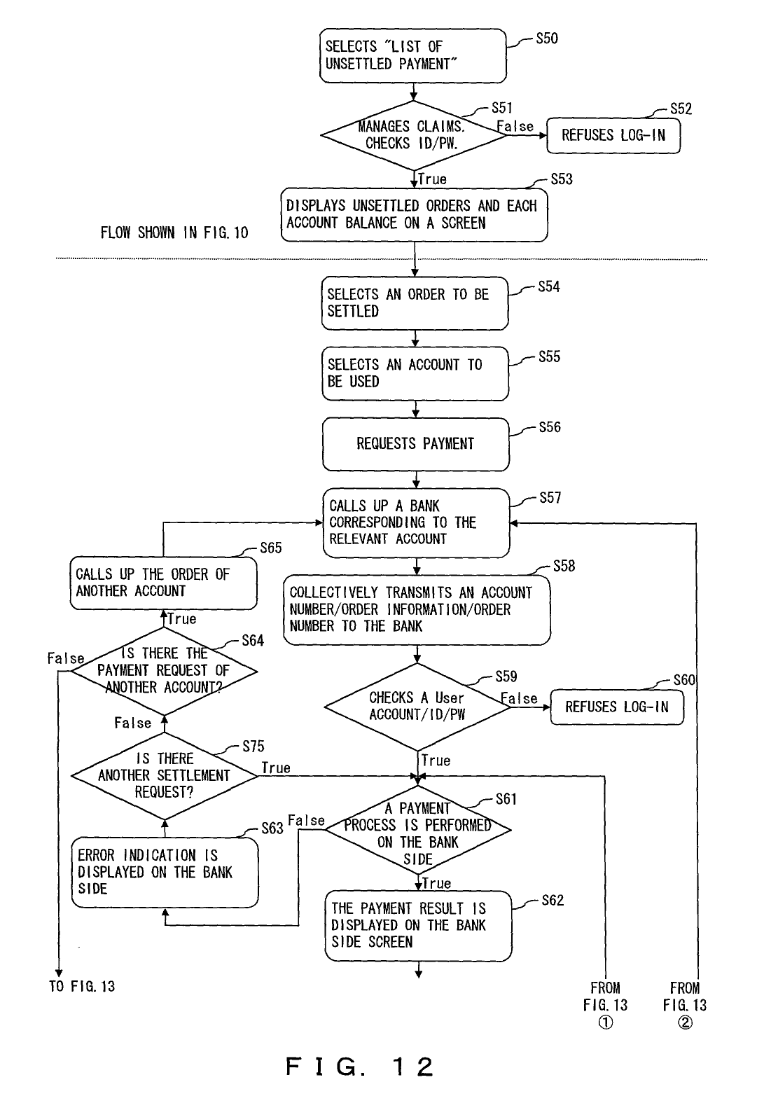

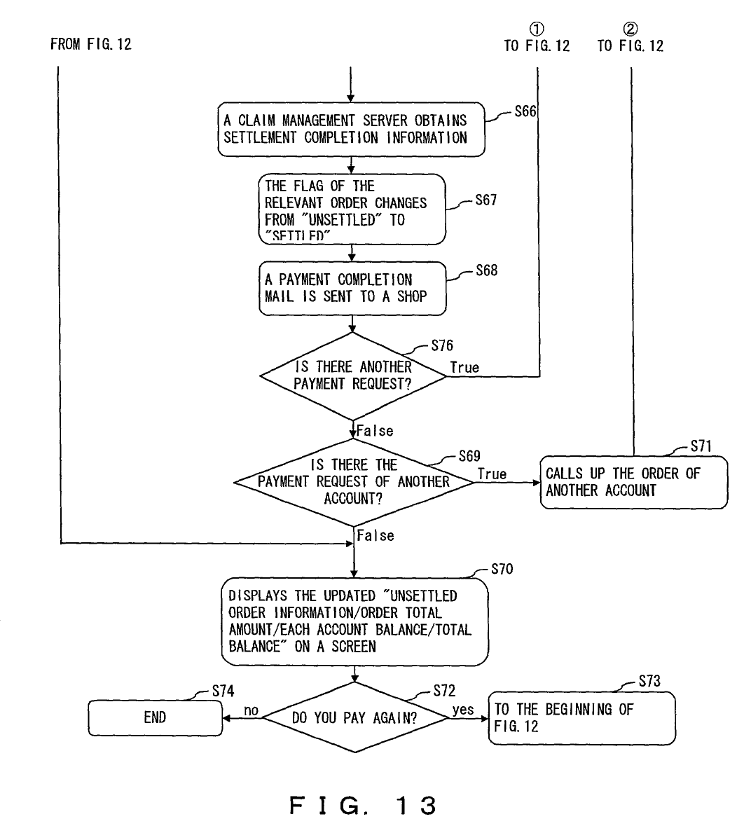

FIGS. 12 and 13 are flowcharts showing processes ranging from the selection of a payment receiver account till a payment process.

First, in step S50, the display of a list of unsettled payment is selected. In step S51, a user is logged in the service of a claim management server by using the user ID and password. If the user is not authenticated, in step S52 the log-in is refused. If the user is authenticated, in step S53 both unsettled orders and each account balance are displayed on the user's screen. In this process, the process described with reference to FIG. 11 is performed. Then, in step S54, an order to be settled is selected. In step S55, an account to be used is selected and the estimated account after the payment is displayed. In step S56, the user requests payment settlement.

Then, in step S57, a bank, to which the relevant account belongs and in step S58, an account number, order information and an order number are collectively transmitted to the relevant bank. In step S59, in order to receive the payment service of the bank, the user inputs both his/her ID and password. If the user is not authenticated, the flow proceeds to step S60 and the log-in of the user in the bank service is refused. If the user is authenticated, in step S61 a payment process is performed on the bank side. If the user is not authenticated, the flow proceeds to step S63 and the bank side makes error indication on the user's screen. In step S75, there is another payment request to be processed for the relevant bank account, the flow returns to step S61 and the process is performed. If it is judged that there is no payment request to be processed for the relevant account, the flow proceeds to step S64. Then, in step S64 it is judged whether there is a payment request for another account. If there is no payment request, the flow proceeds to step S70. If there is a payment request for another account, orders in the account are called up (step S65) and the flow returns to step S57.

If in step S61 the payment is successfully processed, in step S62 the bank side displays the payment result. Then, in step S66 the claim management server obtains payment completion information, in step S67 the flag of the relevant order (flag provided to distinguish “settled” from “unsettled”) is changed from “unsettled” to “settled” and in step S68 an electronic mail reporting the payment completion is transmitted to a shop (member shop).

Then, if in step S76 it is judged that there is another payment request for the account of the relevant bank, the flow returns to step S61 shown in FIG. 12 and the request is processed. If in step S76 it is judged that there is no other payment request, in step S69 it is judged whether there is a payment request for another account. If there is a payment request for another account, the flow proceeds to step S71, orders in the account is called up and the flow returns to step S57. If in step S69 it is judged that there is no payment request, in step S70 the updated “unsettled orders, total order amount, each account balance and total balance” are displayed on the user's screen and in step S72 it is asked if the user is going to make another payment settlement. If in step S72 the user designates another payment settlement, the flow returns to the beginning. If in step S72 the user designates payment termination, in step S74 the process is terminated.

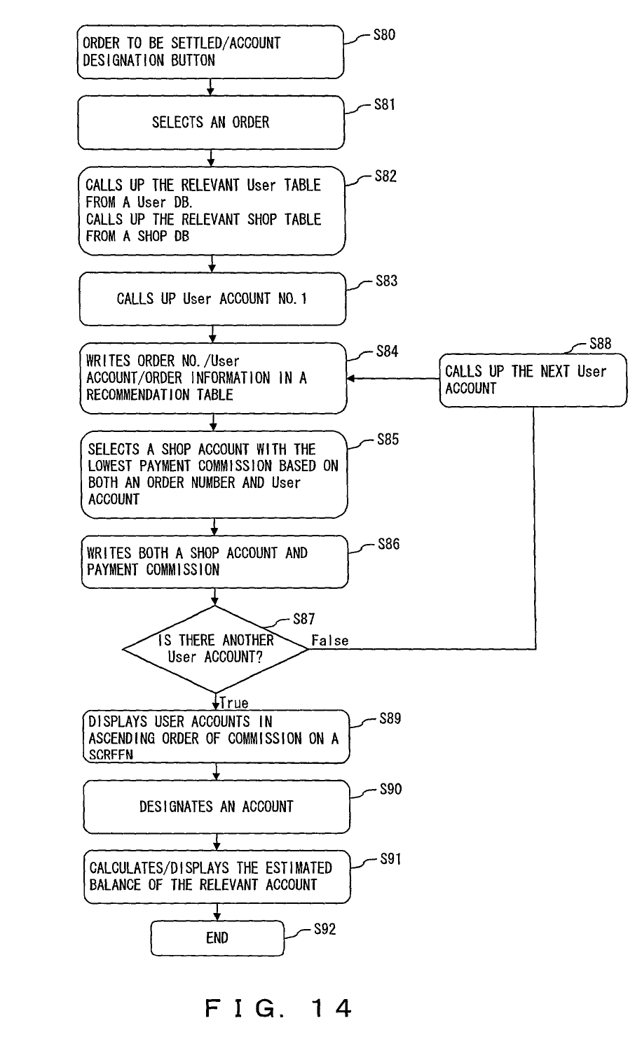

FIG. 14 is a flowchart showing a process of recommending an account to be used to a user.

First, in step S80, a user operates buttons designating an order to be settled and an account. Then, in step S81, the user selects an order. Then, in step S82, a claim management server reads a corresponding user table from a user database and calls up a corresponding shop table. Then, in step S83 the first user account is called up and in step S84 an order number, a user account and order information are written in a recommendation table. Then, in step S85, a shop account with the lowest payment commission is selected based on both the order price and user account while referring to a commission database. Then, both the shop account and payment commission are written in a display table and in step S87 it is judged whether there is another user account. If in step S87 it is judged that there is another user account, in step S88 the next user account is called up and the flow returns to step S84.

If in step S87 it is judged that there is no other user account, in step S89 account handling institutes and the respective commission are displayed on a screen in ascending order of commission based on data written in the display table. Then, in step S90, the user views the screen and designates an account. Then, in step S91, the estimated balance of the relevant account is calculated and displayed. Then, in step S92 the process is terminated.

In this case, in step S85, a shop account with the lowest payment commission is selected by retrieving data from a payment commission table, which is described later.

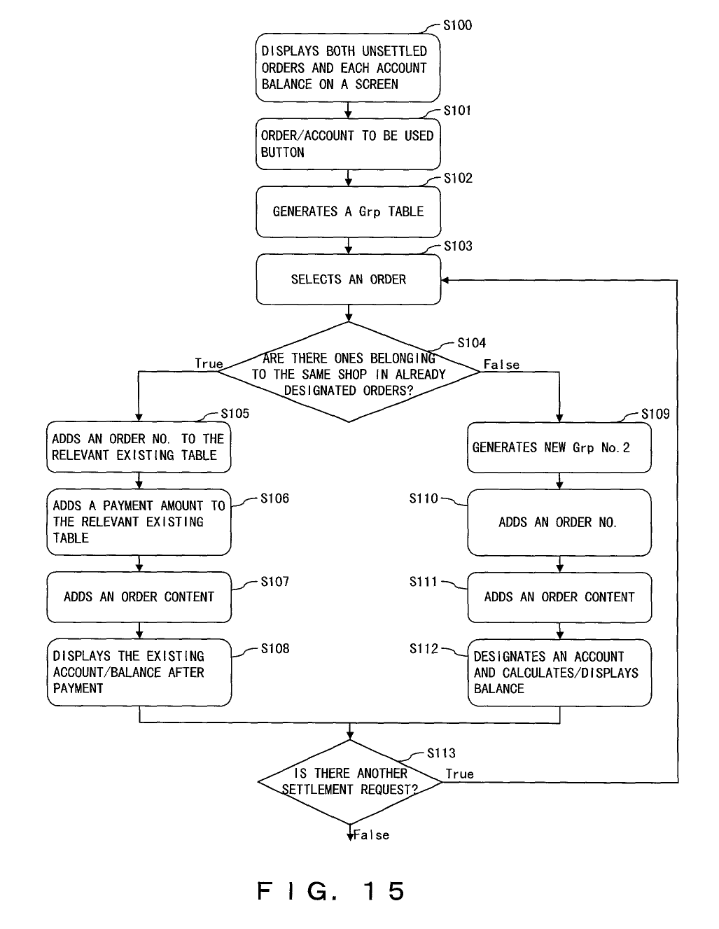

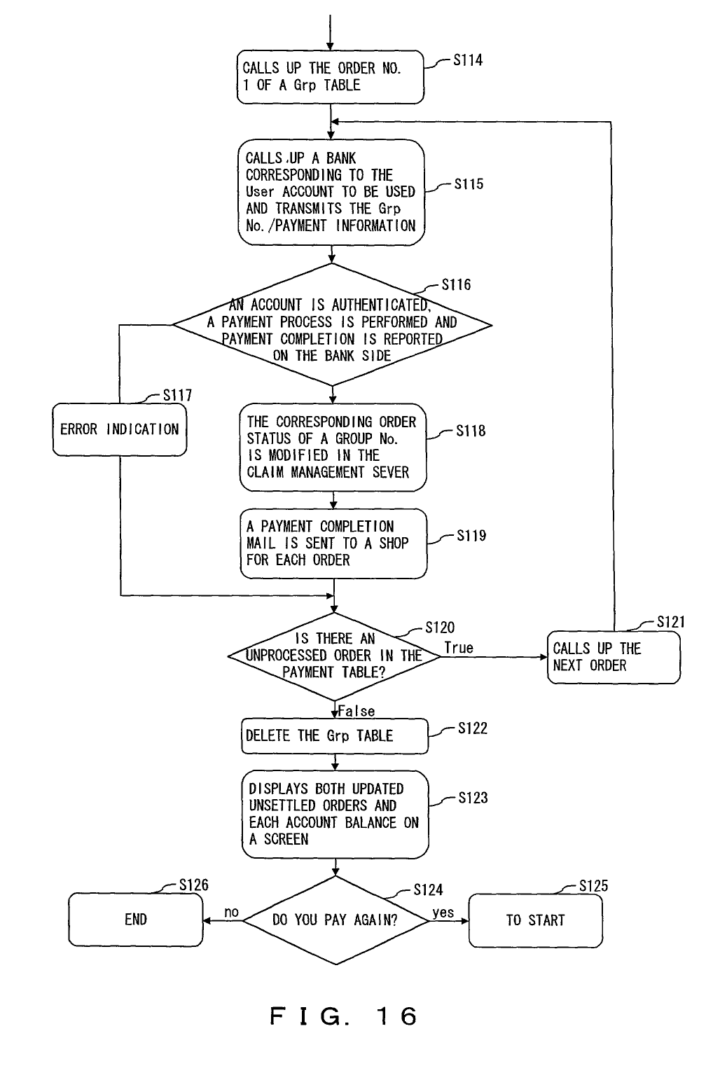

FIGS. 15 and 16 are flowcharts showing a process of grouping orders to be settled.

First, in step S100, both unsettled orders and each account balance are displayed on a user's screen. Then, if in step S101 the user operates an order/account selection button and designates grouping, in step S102 a process of generating a group table starts. In step S103, the user selects orders to be grouped and in step S104 it is judged whether there are orders for the same shop in the already designated orders. If the judgment in step S104 is “true”, in step S105 the order number is added to the relevant existing table and in step S106 the payment amount is added to the relevant existing table. Then, in step S107, the order content is added. In step S108, the existing accounts, commission and each balance are displayed and the flow proceeds to S113.

If the judgment in step S104 is “false”, in step S109 a new group number is generated, in step S110 an order number is added and in step S111 an order content is added. In step S112, the user designates an account, the balance is calculated, the result is displayed and the flow proceeds to step S113.

In step S113 it is judged whether there is another payment request. If there is another payment request, the flow returns to step S103. If there is no other payment request, the flow proceeds to step S114. In step S114, the order number of a group table is called up. Then, in step S115, a bank with an account to be used is called up and both the group number and payment information are transmitted to this bank.

Then, in step S116, the bank side authenticates the account, processes payment and reports payment completion and it is judged whether these processes are normally performed. If the processes are normally performed, in step S117 error indication is made and the flow proceeds to step S120. If in step 116 the processes are normally performed, the flow proceeds to step S118 and a claim management server modifies the status of an order corresponding to the group number. Then, in step S119, a payment completion mail is transmitted to a shop for each order by electronic mail.

In step S120 it is judged whether there is an unsettled order in a payment table. If there is an unsettled order, the flow proceeds to step S121 and then returns to S115. If in step S120 it is judged that there is no unsettled order in the payment table, in step S122 the group table is deleted and in step S123 updated “unsettled orders and each account balance” are displayed on the user's screen. Then, in step S124 it is judged whether the user makes another payment settlement. If the user makes another settlement, in step S125 the flow returns to the beginning. If in step S124 it is not judged that the user makes another payment settlement, in step S126 the process is terminated.

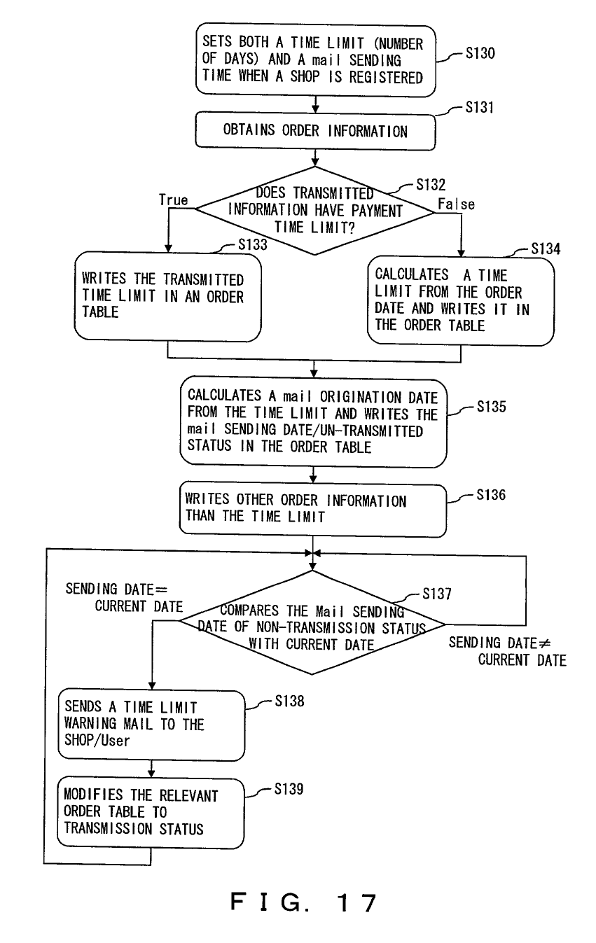

FIG. 17 is a flowchart showing a process of sending a warning message to both a shop and a user when an overdue order is deleted.

First, in step S130, when a shop where a user has done shopping is registered, both the number of days allowed to pay and a mail sending date are set. Then, in step S131 the order information is obtained. Then, in S132 it is judged whether there is a payment time limit in the transmitted information. If there is a payment time limit, in step S133 the transmitted payment time limit is written in an order table and the flow proceeds to step S135. If in step S132 there is no payment time limit, in step S134 the time limit is automatically calculated based on the date of order, the date is written in the order table and the flow proceeds to step S135.

In step S135, the mail sending date is calculated based on the payment time limit and both the mail sending date and non-transmission status are written in the order table. In step S136, other order information than the time limit is written in the order table and the flow proceeds to step S137. In step S137, the mail sending date of an order with non-transmission status and the current date are compared. If as a result of the comparison in step S137, they are different, the process in step S137 is repeated. If they are the same, in step S138 a time limit warning mail is set to both a shop and a user, in step S139 a transmission status is established in the relevant order table and the flow returns to step S137. This time limit warning mail can also be sent a prescribed days before the payment time limit. Alternatively, the time limit warning can be reported on a user's screen immediately after the user is logged in the system.

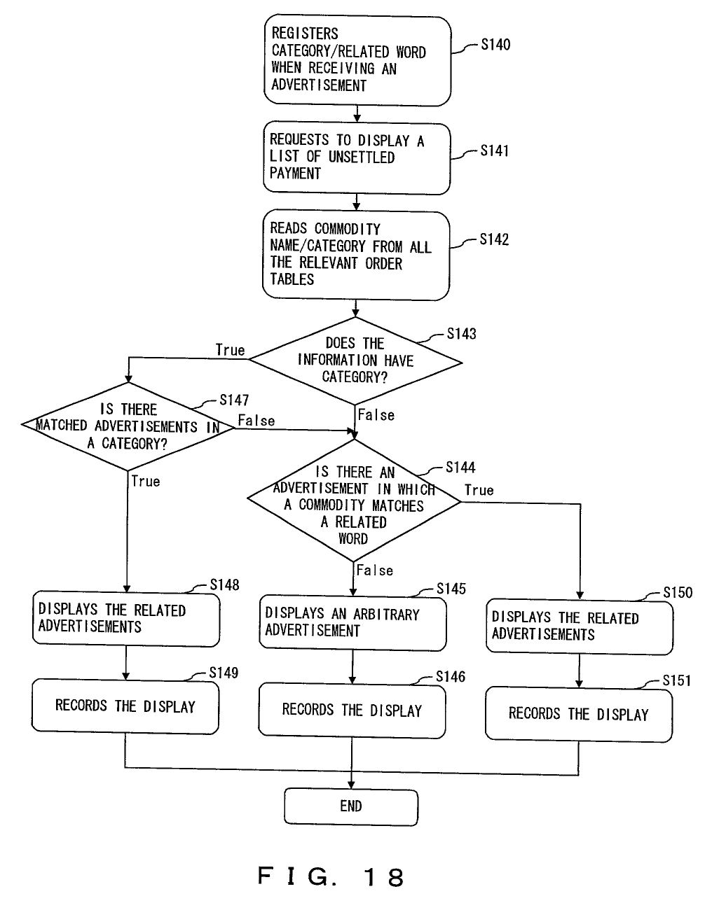

FIG. 18 is a flowchart showing a process of putting a related advertisement on a list of unsettled payment.

In this preferred embodiment, by displaying a banner advertisement related to a commodity that a user has purchased, etc., on an unsettled payment list screen, commodities in which the user is anticipated to be interested can be advertised and the sale of the commodities can be promoted.

First, in step S140, when an advertisement request is received from an advertisement client, both the category of an advertised commodity and a related word are registered. Then, if in step S141 there is the display request of a list of unsettled payment, in step S142 both the description of commodities and the categories are read from all corresponding order tables. Then, in step S143 it is judged whether the information read in step S142 includes a category. If a category is included, in step S147 it is judged whether there is an advertisement belonging to the category. If there is an advertisement belonging to the category, in step S148 the advertisement is displayed. Then, in step S149, the display of the advertisement is recorded and the process is terminated.

If in step S143 it is judged that the information read in step S142 does not include a category or if in step S147 it is judged that there is no advertisement belonging to the category, in step S144 it is judged whether there is an advertisement in which a commodity and a related word are matched. If in step S144 there is such an advertisement, in step S150 the advertisement is displayed, in step S151 the display is recorded and the process is terminated.

If in step S144 it is judged that there is no advertisement in which a commodity and a related word are matched, in step S145 an arbitrary advertisement is displayed, and in step S146 the display is recorded and the process is terminated.

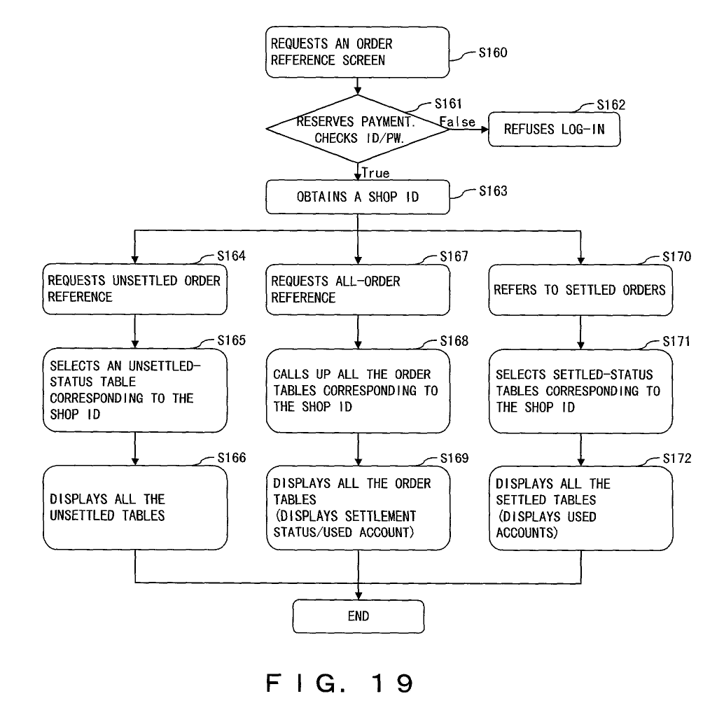

FIG. 19 is a flowchart showing a process performed when a shop makes an inquiry about an order status of a claim management server.

If in step S160 there is the display request of an order reference screen from a shop, in step S161 a claim management server instructs the shop to input the shop ID and password in order to log the shop in the payment reservation service of the claim management server. If in step S161 the shop is not authenticated, in step S162 the log-in is refused. If in step S161 the shop is authenticated, in step S163 the shop ID is obtained.

If an unsettled order reference request is issued (step S164) from a shop, the flow proceeds to step S165, an unsettled payment status table corresponding to the shop ID is selected, in step S166 an all-unsettled table is displayed and the process is terminated. If an all-order reference request is issued from a shop (step S167), in step S168 an all-order table corresponding to the shop ID is called up and in step S169 the all-order table is displayed. The all order table includes settled payment statuses, used accounts, etc.

If a settled order reference request is issued from a shop (step S170), a settled payment status table corresponding to the shop ID is selected and in step S172 all the settled tables are displayed. In this case, used accounts are displayed.

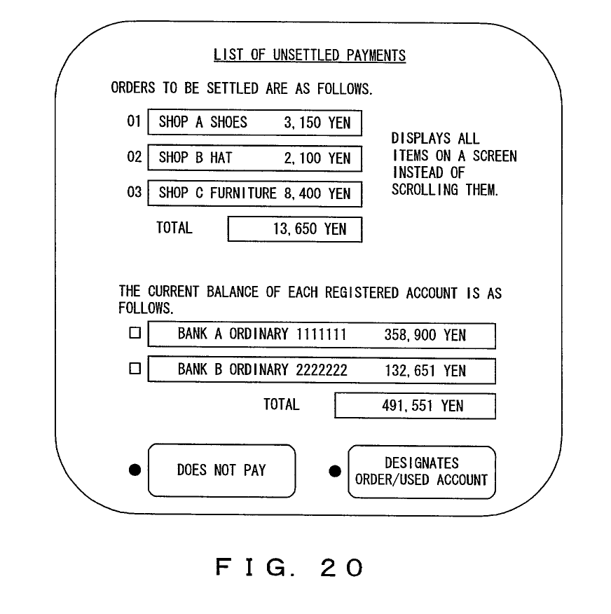

FIG. 20 shows one unsettled payment selection screen of the unsettled payment list screen.

As shown in FIG. 20, on a list of unsettled payment, orders to be settled and the total amount are displayed. In FIG. 20, a user purchases a pair of shoes at 3,150 yen at shop A, a hat at 2,100 yen at shop B and a piece of furniture at 8,400 yen at shop C. The total purchase amount is 136,650 yen.

On the list of unsettled payment, the name of a bank with the account currently registered by the user, an account type, an account number and balance are displayed. FIG. 20 shows that the user registers his/her accounts in both banks A and B, the balance of banks A and B are 358,900 and 132,651 yen, respectively, and the total balance is 491,551 yen.

At the bottom of the screen, there are a button for designating no payment and a button for moving to a screen for designating an order and an account to be used for payment.

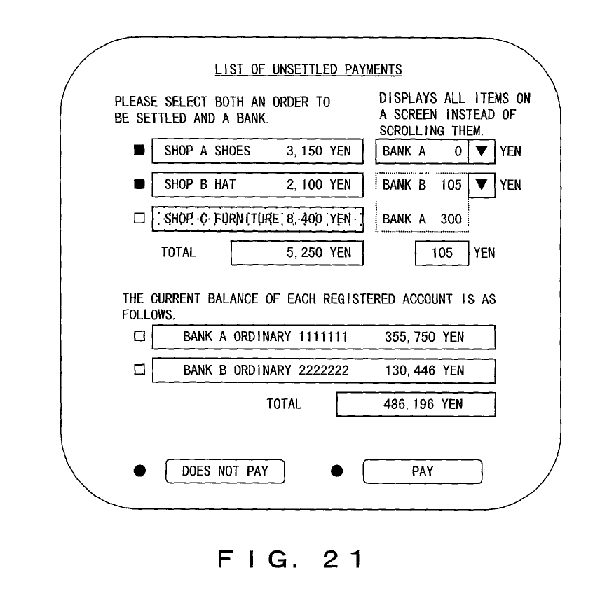

FIG. 21 shows one order/account setting process screen of the unsettled payment list screen.

FIG. 21 shows how both an order and an account are selected to make a payment. As an order to be settled, both shopping items at shops A and B are selected and the total payment amount to be paid is 5,250 yen. If an account recommendation service is provided, each commission required to make the payment of the price of these shopping items using bank A or B is indicated to the right of the order selection screen and each estimated balance after the payment is indicated below the order selection screen.

Information about accounts registered by the user is indicated as in FIG. 20. Furthermore, at the bottom of this screen, buttons for a user designating payment/no payment are provided.

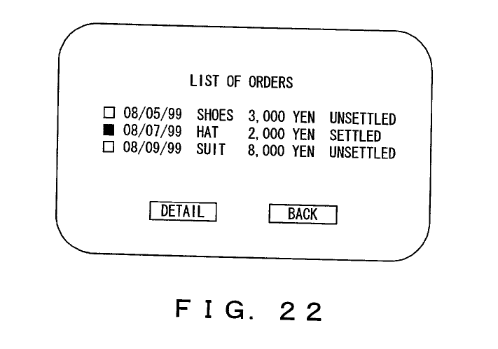

FIG. 22 shows one order list screen displayed when a shop makes an inquiry about an order status of a claim management server.

FIG. 22 shows that a pair of shoes has been purchased at 3,000 yen on Aug. 5, 1999 and the price is not paid. Similarly, FIG. 22 shows that a hat has been purchased at 2,000 yen on Aug. 7, 1999 and the price is already paid and that a suit has been purchased at 8,000 yen on Aug. 9, 1999 and the price is not paid.

As shown in the screen example, the preferred embodiment has an advantage that a user and a shop can easily manage shopping and sale, respectively.

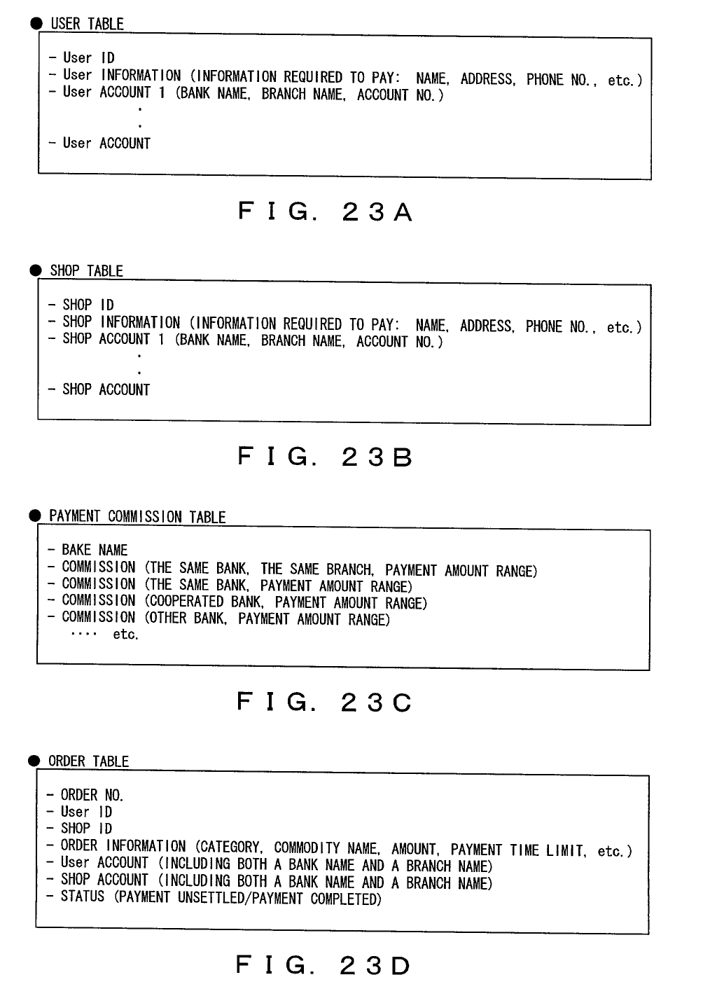

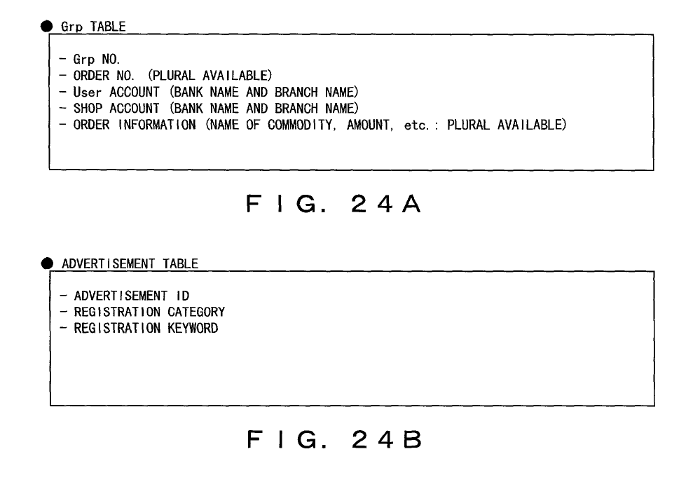

FIGS. 23A through 23D and 24A and 24B show examples of the construction of each table.

FIG. 23A shows a user table, and information necessary for payment (name, address, phone No., etc.), a user account (bank name, branch name, account type, account No.) is registered as user information in addition to a user ID. The number of user accounts is arbitrary.

FIG. 23B shows a shop table, and information necessary for payment (name, address, phone No., etc.), a shop account (bank name, branch name, account type, account No.) is registered as shop information in addition to a shop ID. The number of shop accounts is arbitrary.

FIG. 23C shows a payment commission table, and a list of a variety of commission, such as commission in the case where a payment amount is within a prescribed range at the same branch of the same bank, commission in the case where a payment amount is within a prescribed range at the same bank, commission in the case where a payment amount is within a prescribed range at an affiliated bank, commission in the case where a payment amount is within a prescribed range at another bank, etc., are registered in addition to the name of a bank.

FIG. 23D shows an order table, and order information, such as an order number, a user ID, a shop ID, a category, the description of a commodity, an amount, a payment time limit, the sending date of a deletion warning mail, etc., a user account (bank name, branch name, etc.), a shop account (bank name, branch name, etc.), and unsettled/settled statuses are registered.

FIG. 24A shows a group table, and a group number, a single or plurality of order numbers, a user account (bank name, branch name, etc.), a shop account (bank name, branch name, etc.), and a single or plurality of pieces of order information (commodity name, amount, etc.) are registered.

FIG. 24B shows an advertisement table, and an advertisement ID, a registration category, a registration keyword (related word), etc., are registered.

Next, another preferred embodiment of the present invention where both a shop and a user receive a payment reservation service using the same bank is described.

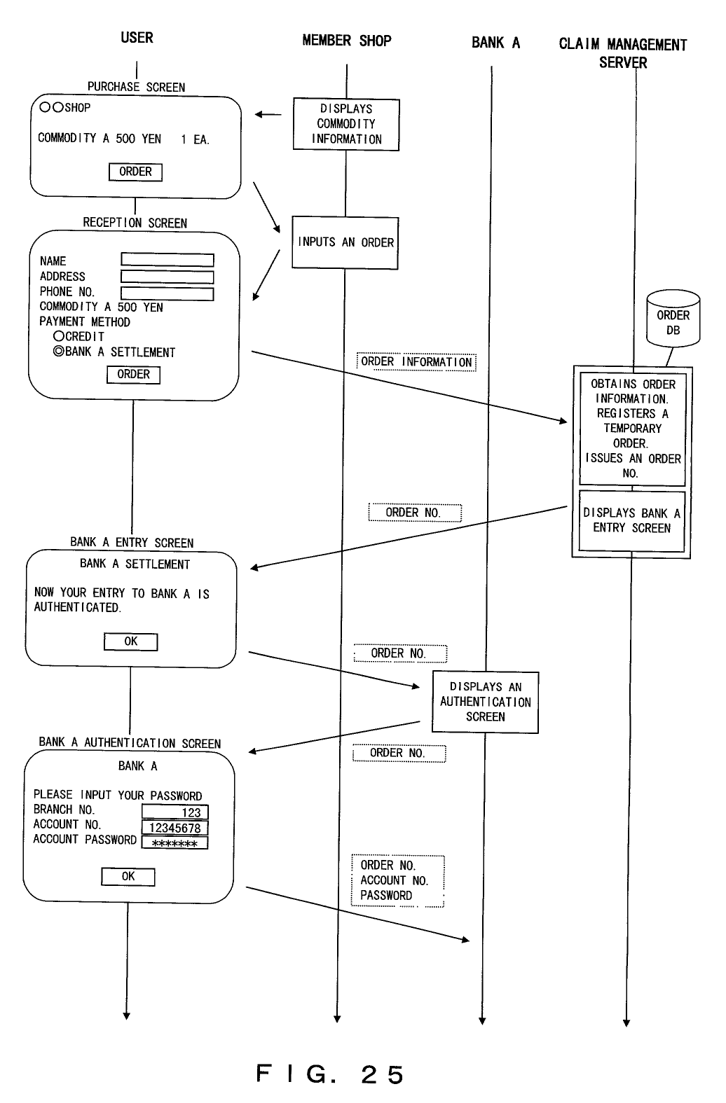

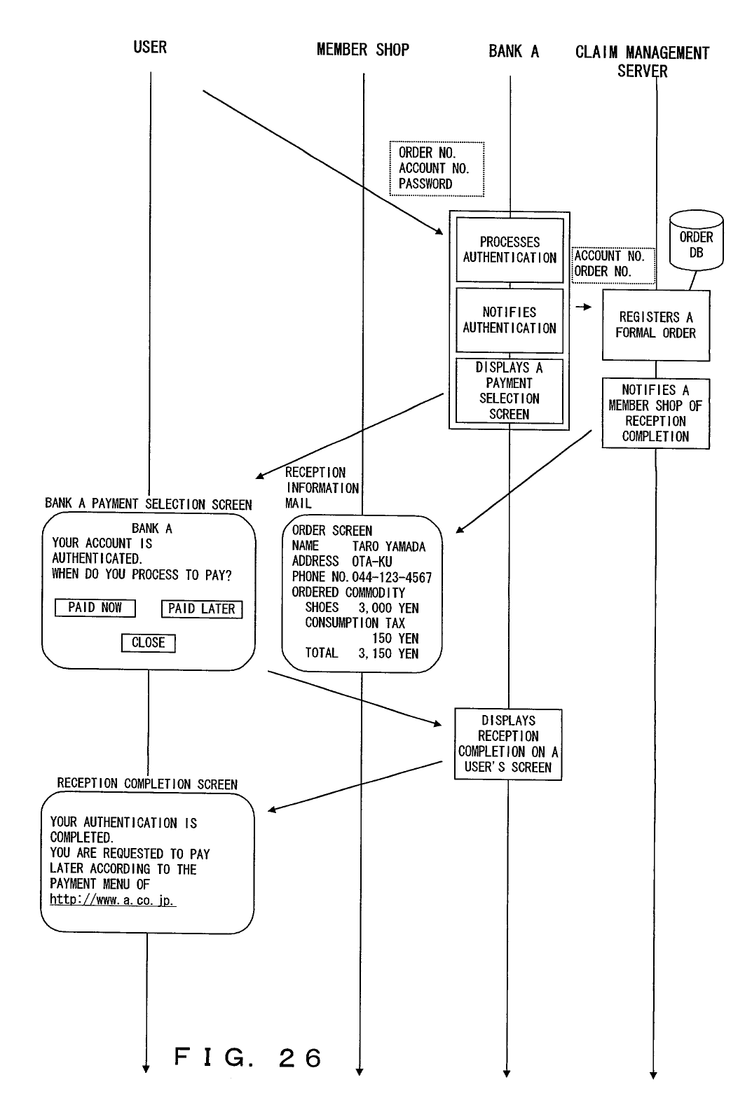

FIGS. 25 and 26 are sequence charts showing the flow of a purchase order reception process in the case of later payment in another preferred embodiment of the present invention.

First, a member shop displays commodity information on a user's screen using a homepage, etc. If the user wants to purchase, he/she places an order using the commodity information. Then, the member shop displays a reception screen for a user inputting order information on the user's screen. The user places an order by inputting his/her name, address, phone number and payment method on this reception screen. It is assumed here that the user selects payment via bank A. Then, the order information is transmitted to a claim management server. The claim management server obtains the order information, temporarily registers the order in an order database and issues an order number. Then, an entry screen to bank A is displayed on the user's screen.

If the user pushes an OK button on the entry screen to bank A, bank A displays an authentication screen for receiving the payment service of bank A. On the authentication screen, the user inputs a shop number, an account number, an account password, etc. On receipt of such information, bank A performs an authentication process. In this case, both the account number and order number are reported to the claim management server, and the order is formally registered in the order database. Then, the claim management server sends an order reception completion notification to the member shop.

If the user is authenticated by bank A, bank A notifies the user of the authentication and simultaneously displays a payment selection screen on the user's screen. On the payment selection screen, the user determines whether he/she settles a payment promptly or later. It is assumed here that the user selects later payment, this information is reported to bank A, and reception completion is displayed on the user's screen.

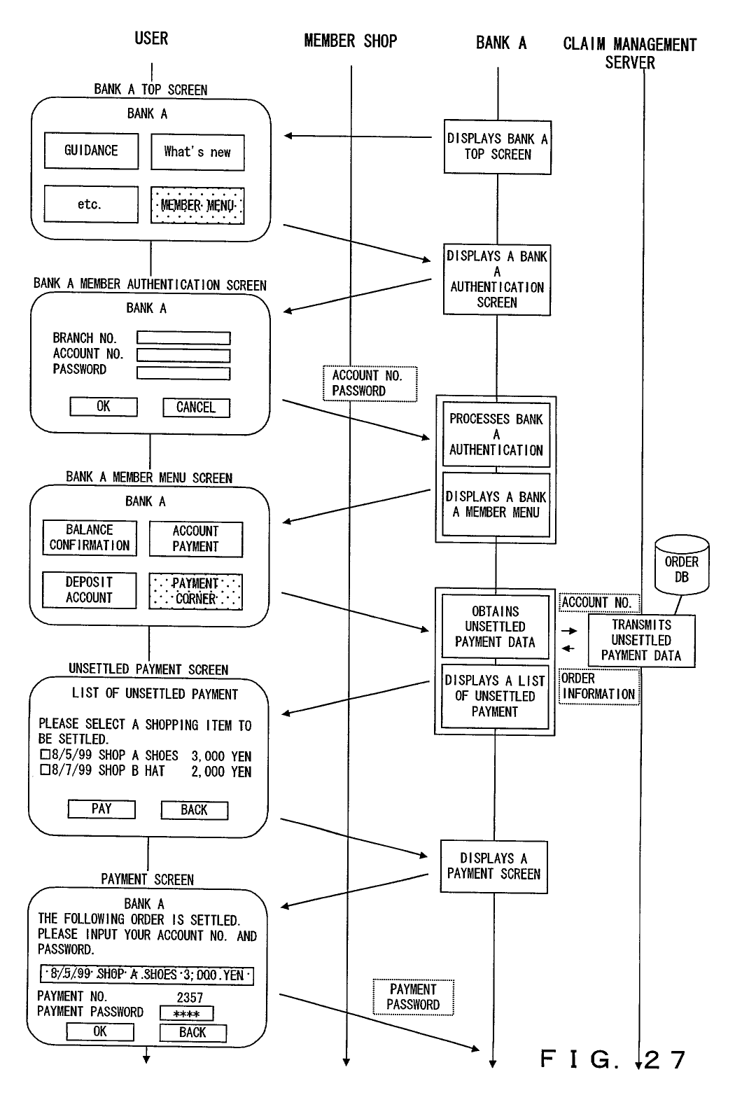

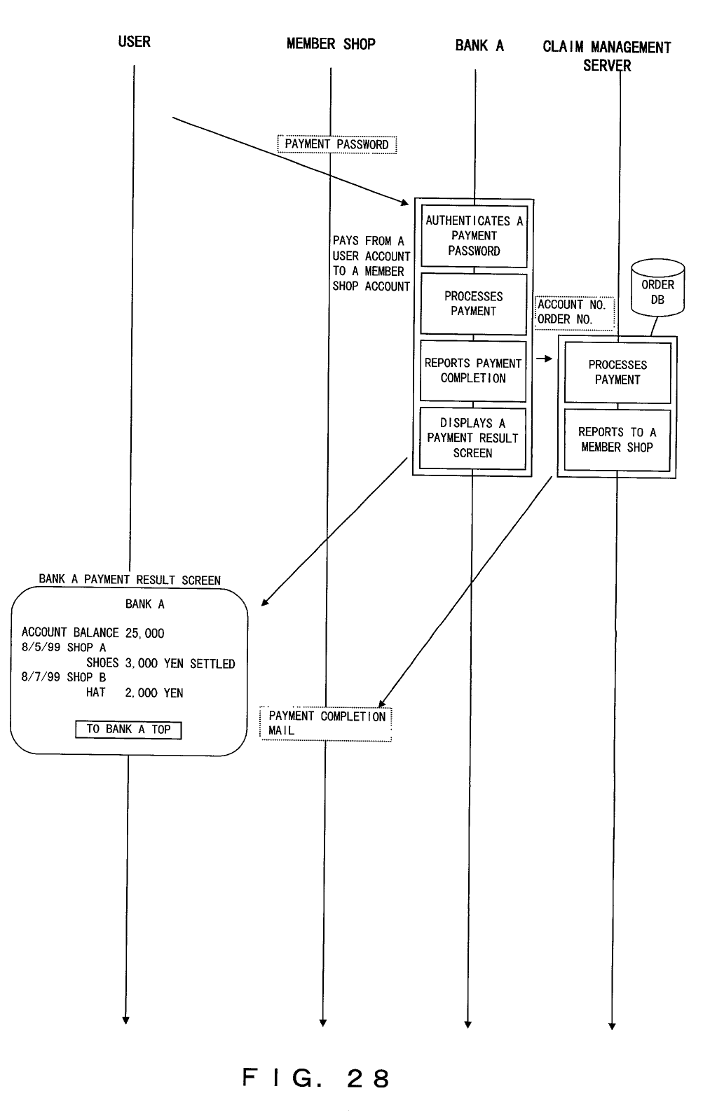

FIGS. 27 and 28 are sequence charts showing the flow of a shopping payment process in the case of later payment in another preferred embodiment.

First, a user displays the top page of a network screen, such as the homepage of bank A, etc. Then, the user selects the member menu of bank A in order to settle a shopping payment. Then, bank A displays an authentication screen for receiving a payment service on the user's screen. The user inputs necessary items, such as a branch number, his/her account number, his/her password, etc., to the authentication screen. The inputted information is transmitted to the server of bank A. Bank A authenticates the user. If the user is authenticated, bank A displays the member menu of bank A on the user's screen. The user selects a payment service from this member menu.

Then, the server of bank A requests a claim management server to obtain unsettled payment data. The claim management server refers to an order database and transmits the unsettled payment data to the bank A server. On receipt of the unsettled payment data, the bank A server displays a list of unsettled payment on the user's screen. The user selects a shopping item to be paid from the list of unsettled payment and designates payment. Then, bank A displays a payment screen on the user's screen.

The user inputs both his/her account number and password in order to settle the payment on the payment screen. On receipt of the information inputted to the payment screen by the user, the bank A server authenticates the user by the password, and then performs a payment process. When the payment process is completed, bank A notifies the claim management server of payment completion. The claim management server performs a settlement process based on both the account number and order number, and updates an order database.

When the settlement process is completed, the claim management server sends a settlement completion mail to the member shop by electronic mail. Bank A also displays a settlement result screen on the user's screen and terminates the process.

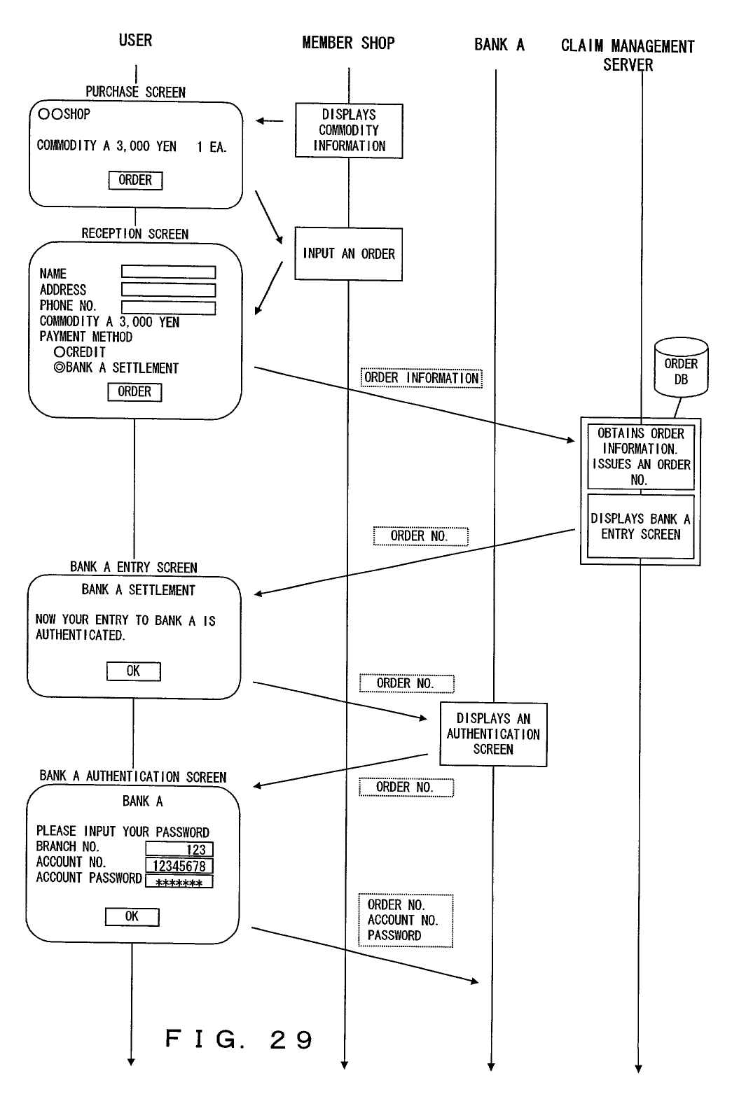

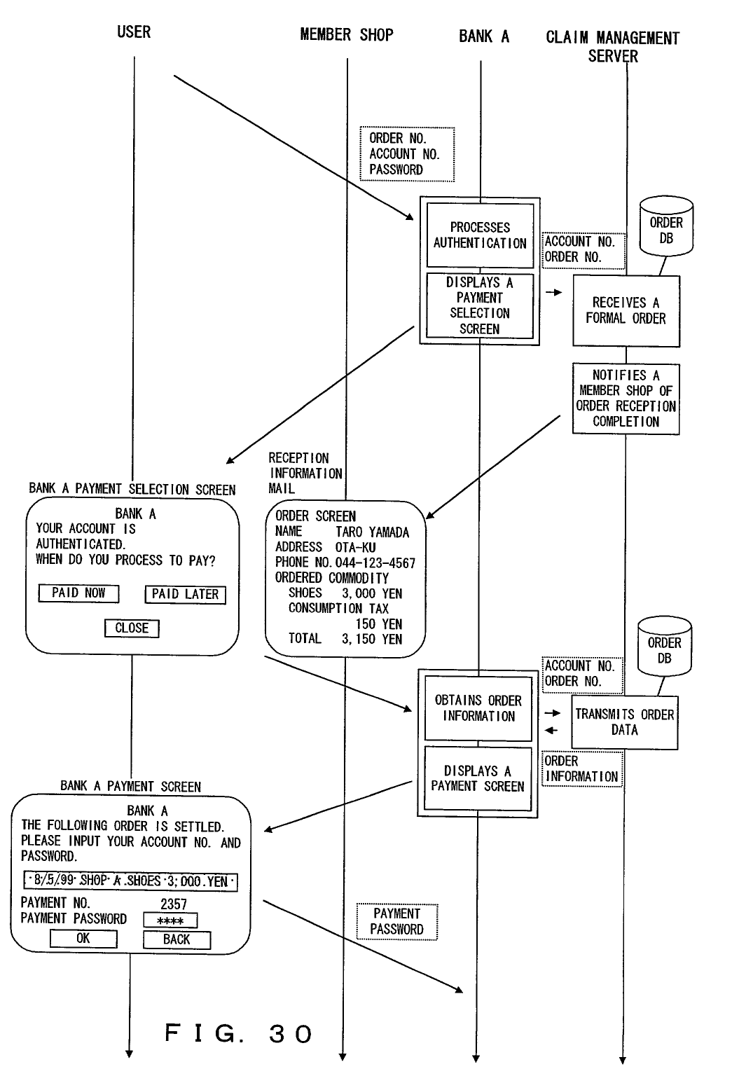

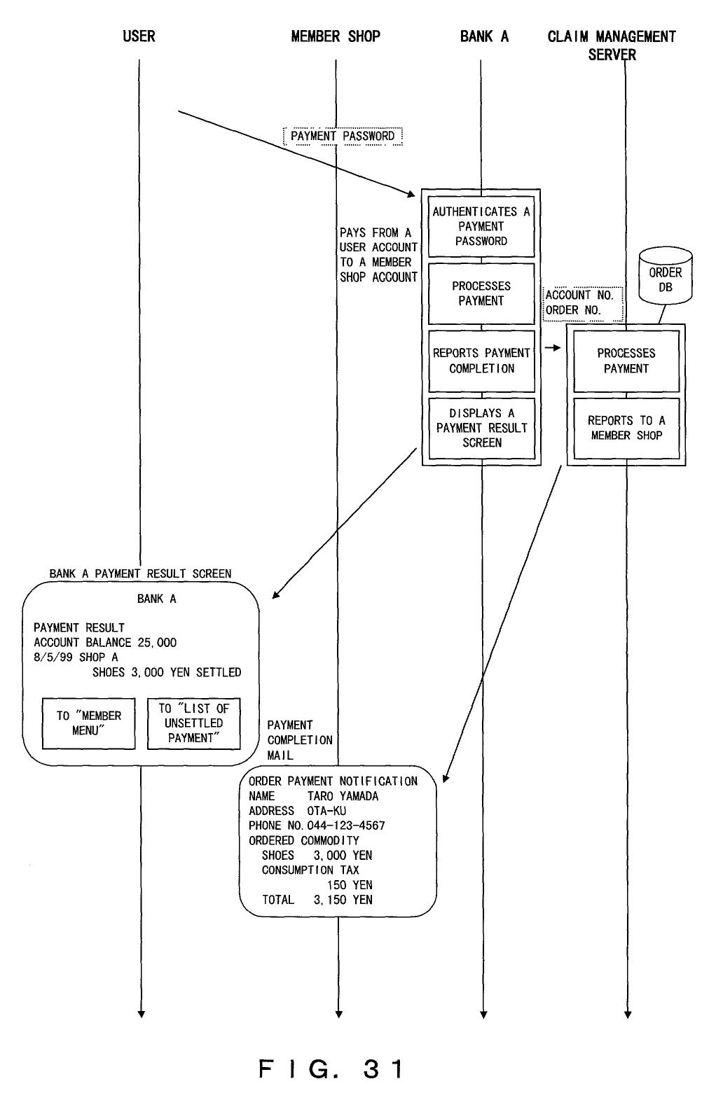

FIGS. 29 through 31 are sequence charts showing a process flow in the case of shopping spot payment in another preferred embodiment.

First, a member shop provides a user with commodity information using a homepage, etc. A user views this screen and places an order for a commodity. On receipt of the order application from the user, the member shop displays an order reception screen on the user's screen. It is assumed that the user inputs necessary items and selects payment via bank A. Then, the order information is transferred to a claim management server. On receipt of the order information, the claim management server registers the order in an order database as a temporary order and issues an order number. Then, the claim management server displays an entry screen to bank A on the user's screen.

If the user pushes an OK button on the entry screen to bank A, the server of bank A displays an authentication screen on the user's screen. The user inputs necessary items to the displayed authentication screen and the information is transferred to the bank A server. The bank A server authenticates the user based on the received information and transmits both his/her account number and order number to the claim management server. On receipt of the successful authentication result, the claim management server formally receives the relevant order in the order database and notifies the member shop of order reception completion.

The bank A server presents a payment selection screen to the user. It is assumed that the user selects spot payment on this screen. Then, bank A notifies the claim management server of both the account number and order number, and makes a request for the order information. On receipt of the request for the order information, the claim management server refers to the order database and transmits the order information to the bank A server. Then, the bank A server presents a payment screen to the user. The user inputs necessary items to the payment screen and the information is transmitted to the bank A server.

The bank A server authenticates the user in order to provide the payment service by the password inputted by the user and performs a payment process. When the payment process is completed, the bank A server notifies the claim management server of payment completion. On receipt of the payment completion notification, the claim management server performs a settlement process, updates the order database and sends a payment completion mail to the member shop by electronic mail. The bank A server also presents a payment result screen to the user and terminates the process.

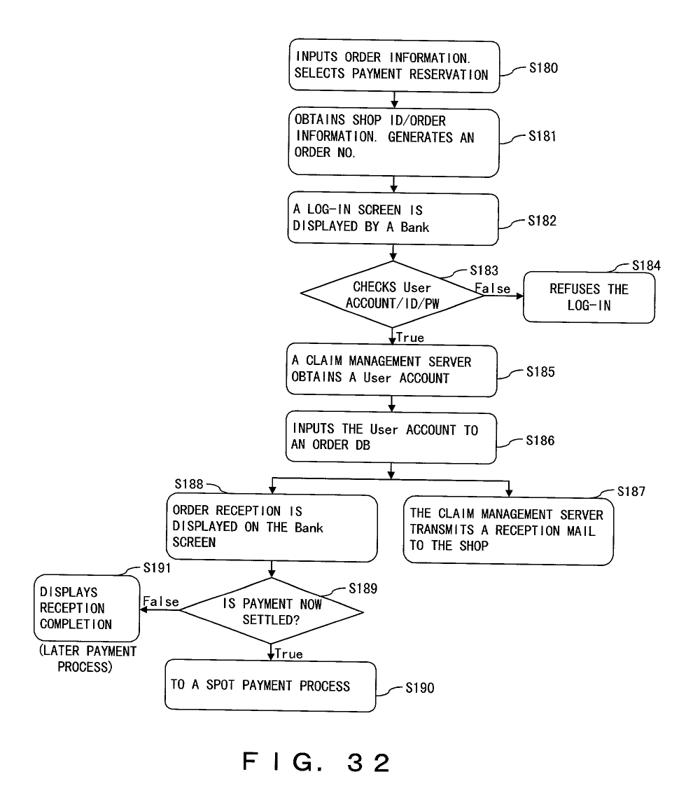

FIG. 32 is a flowchart showing an order reception process in another preferred embodiment.

First, in step S180, a user inputs order information and selects “payment reservation”. Then, in step S181, both a shop ID and order information are obtained and an order number is generated. Then, in step S182, a bank server presents a log-in screen to the user. Then, in step S183, a user account, a user ID and a user password are checked. If log-in fails, in step S184, the log-in is refused. If log-in succeeds, in step S185, a claim management server obtains the account number of the user and in step S186, the account number of the user is inputted to an order database.

Then, in step S187, the claim management server sends an order reception mail to the shop by electronic mail and in step S188, the bank server presents an order reception screen to the user. On the order reception screen, the user makes a payment selection. In step S189, it is judged whether it is spot payment or later payment. If the user selects spot payment, in step S190 the flow proceeds to a spot payment process. If in step S189 the user selects later payment, in step S191 reception completion is displayed and the process is terminated.

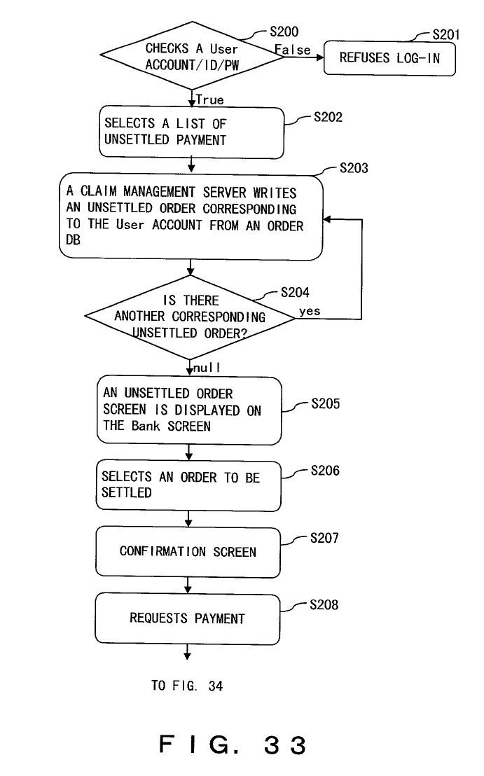

FIG. 33 is a flowchart showing the display process of a list of unsettled payment in another preferred embodiment.

First, a user account number, a user ID and a user password inputted by a user are authenticated (step S200). If they are not authenticated, in step S201 log-in is refused. If they are authenticated, in step S202 the user selects the display of a list of unsettled payment. Then, in step S203, the claim management server writes unsettled orders corresponding to the user ID from an order database and in step S204 it judges whether there is another corresponding unsettled order. If there is another unsettled order, the flow returns to step S203 and the unsettled order is written.

If in step S204 it is judged that there is no other unsettled order, the flow proceeds to step S205 and an unsettled order screen is displayed on the bank screen. Then, the user selects an order to be settled on this unsettled order screen (step S206), in step S207, a confirmation screen is displayed and in step S208, the user inputs a settlement request.

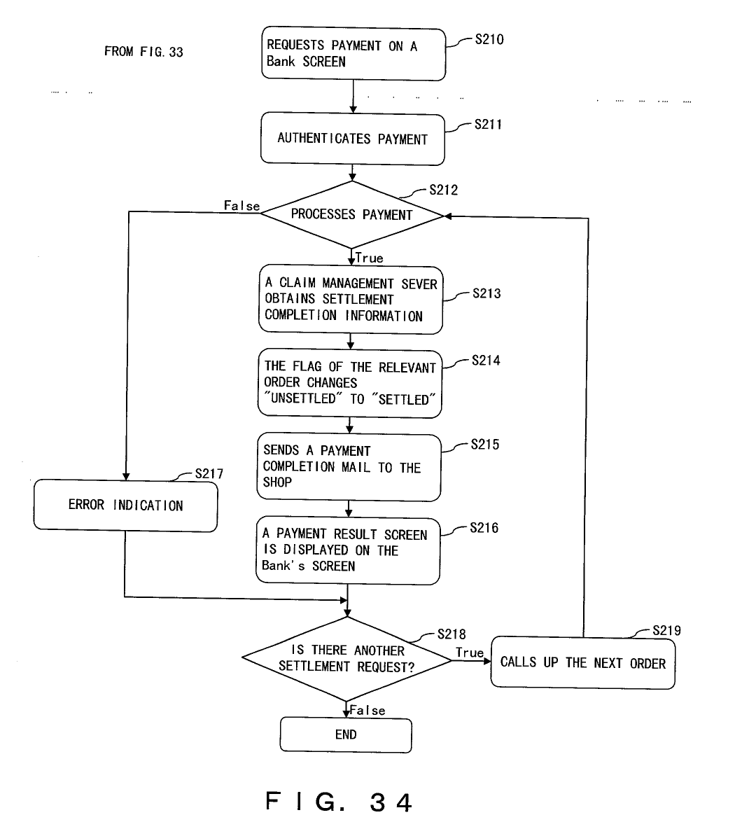

If in step S208 a settlement request is inputted, the flow proceeds to the process shown in FIG. 34.

FIG. 34 is a flowchart showing a payment process in another preferred embodiment.

First, if in step S210 a user makes a settlement request on the user's bank screen, in step S211 a payment authorization process is performed. If the payment is authenticated, in step S212 a payment process is performed. If the payment is not authenticated, in step S217 error indication is made and the flow proceeds to step S218. If the payment succeeds, the flow proceeds to step S213 and a claim management server obtains payment completion information from a bank server. In step S214, the claim management server modifies the setting of the relevant order flag (flag indicating “unsettled”/“settled” payment) from “unsettled” to “settled”. Then, in step S215, the claim management server sends a payment completion mail to a shop by electronic mail. In step S216, the claim management server displays a payment result screen on the user's bank screen. Then, in step S218, the claim management server judges whether there is another settlement request. If there is another settlement request, in step S219 the next order is called up and the flow returns to step S212. If in step S218 it is judged that there is no other settlement request, the process is terminated.

The flowcharts shown in FIGS. 15 through 19 can also be applied to the other preferred embodiments described above. However, since the processes are the same as those described above, the descriptions are omitted.

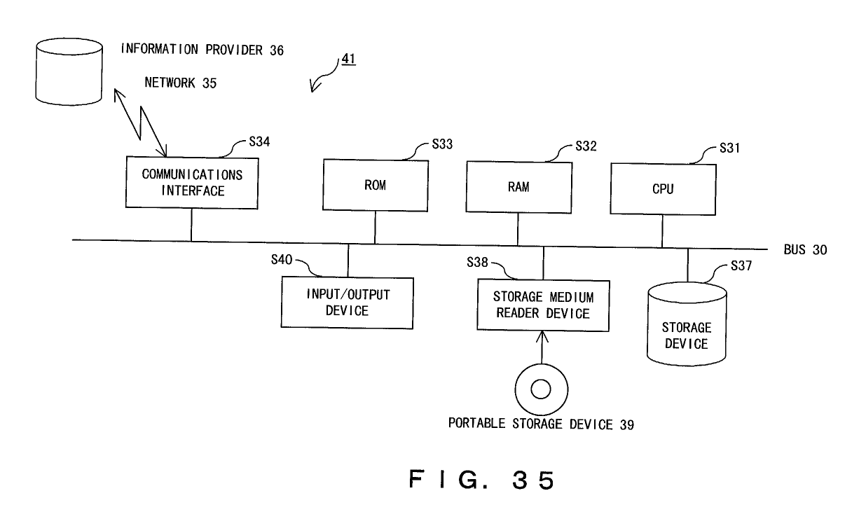

FIG. 35 shows the general hardware configuration of a claim management server in each preferred embodiment or the server of an account handling institute (bank).

A CPU 31 is connected to a RAM 32, a ROM 33, a communications interface 34, a storage device 37, a storage medium reader device 38 and an input/output device 40 via a bus 30. The ROM 33 stores a basic program, such as BIOS, etc., and enables the operation of the basic functions of a system 41. Alternatively, if there is no need to modify the operation of the system 41 later, the program for enabling a computer to implement the process in the preferred embodiment of the present invention can be stored in the ROM 37 and the CPU 31 can execute the process.

Generally, the program for enabling a computer to implement the process in the preferred embodiment of the present invention is stored in the storage device 37, such as a hard disk, etc., and the CPU 31 transfers the program from the storage device 37 to the RAM 32 to make the RAM store the program, and executes the program. The program is copied to the storage device 37 by storing the program in a portable storage medium 39, making the CPU 31 read the program using the storage medium reader device 38 and storing the program in the storage device 37. For the portable storage medium 39, a CD-ROM, a floppy disk, a DVD, etc., are used. For the storage medium reader device, a CD-ROM drive, a floppy disk drive, a DVD drive, etc., are used.

The input/output device 40 is composed of a display, a keyboard, a mouse, etc., and it is used for an operator to input necessary settings and to monitor the operation state of a system when the system 41 is used as a server.

The communications interface 34 communicates with an information provider 36 via a network 35, and it can be used to download data and a program required to implement the preferred embodiment of the present invention from the information provider 38 to the storage device 37. Since a claim management server and account handling institute servers belongs to a plurality of systems 41, the program can also be executed in a network environment by connecting these systems 41 using a network 35, such as a LAN, etc.

The present invention is not limited to the preferred embodiments described above, and a variety of variations can also be implemented without the modification of the subject matter of the present invention.

For example, although in the preferred embodiments, the description is given using online shopping as an example, the application is not limited to this. For example, the present invention can also be applied to the payment of an offline transaction, such as the payment of public utility charges, such as telephone charge, water service charge, etc. In this case, it is preferable for a claim management server 23 to be configured to receive claim data from a telephone company, the water works bureau, etc., online.

In this case, it is preferable for a system to be configured so that no invoice is not issued. However, since in this case, a user cannot know when he/she is claimed, it is preferable for a system to be configured so that the relevant user is notified of by mail or on a screen after log-in when there is a new claim.

In the preferred embodiments described above, it is configured so that the payment of a plurality of pieces of shopping can be settled at one time by grouping them. In this case, for example, it is preferable for a system to be configured so that if out of the plurality of pieces of grouped shopping, even one cannot be settled due to short balance, the payment of the entire grouped shopping can be cancelled and resettled.

The present invention is applicable to an offline transaction, such as public utility charges in addition to an online shopping on a network in addition to an online shopping on a network. In this case, shopping items to be settled can be accumulated and stored in a form of “payment reservation” instead of making a spot payment and the payment can be collectively settled later. The payment of a shopping item across a plurality of account handling institutes can also be settled.

Therefore, a user can accumulate and store a plurality of orders to be settled in one place, can confirm orders to be settled at a glance and payment work conventionally required to settle payment can be simplified.

A shop can omit the check work of orders by bank account settlement, the sales management of orders by bank account settlement can be simplified and a fund collection period can be shortened since in bank account settlement, payment can be immediately settled.

By making a claim management server do check work in place of a shop and presenting orders to be settled to a user, an account handling institute can increase the number of settled payment by bank account settlement (payment commission) and can provide both a user and a member shop with the online settlement service of e-commerce and public utility charges.

What is claimed is:

1. An online settlement system for settling payment of a transaction online, comprising:
a transaction content storage unit storing a transaction content of a user;
an unsettled payment list display unit presenting transaction contents, the price of which is not paid, out of the transaction contents stored in the transaction content storage unit at a request from the user; and
a payment unit enabling the user to pay a price of a transaction content to be settled by the user using an account handling institute.

2. The online settlement system according to claim 1, wherein said transaction content storage unit receives online a content of a transaction conducted online by a user and stores the content.

3. The online settlement system according to claim 1, wherein said transaction content storage unit receives online a content of a transaction conducted offline by a user from a transaction partner of the user and stores the content.

4. The online settlement system according to claim 1, further comprising
a unit notifying a user of a payment request if a transaction content of a user is received from the transaction partner.

5. The online settlement system according to claim 1, wherein the account handling institute can settle a payment online.

6. The online settlement system according to claim 1, further comprising
a deletion unit deleting a settled item from a transaction content stored in said transaction content storage unit.

7. The online settlement system according to claim 6, wherein said deletion unit stores a settled item in a settled transaction content storage unit.

8. The online settlement system according to claim 1, further comprising
a user payment history display unit displaying user's past payment histories at a request from the user.

9. The online settlement system according to claim 1, further comprising
a transaction content list display unit displaying a list of transaction contents conducted with a transaction partner at a request from the transaction partner of a user.

10. The online settlement system according to claim 9, further comprising
a transaction partner payment history display unit displaying past payment histories of a transaction partner at a request from the transaction partner.

11. The online settlement system according to claim 1, further comprising
an account handling institute recommendation unit recommending an appropriate account handling institute to be used to the user if there are a plurality of the account handling institutes.

12. The online settlement system according to claim 1, further comprising
a notification unit notifying a transaction partner of payment of a price of a transaction, which is settled by the user.

13. The online settlement system according to claim 1, said transaction content storage unit further comprising
a warning unit setting a payment time limit to each transaction and warning the user against the payment when the payment time limit of each transaction comes a prescribed number of days before.

14. The online settlement system according to claim 13, wherein said warning unit warns a user against payment when the user is logged in this online settlement system.

15. The online settlement system according to claim 13, wherein said warning unit warns a user against payment by electronic mail.

16. The online settlement system according to claim 1, wherein a payment time limit of each transaction is set in said transaction content storage unit and the transaction content of each transaction is deleted when the payment time limit is expired.

17. The online settlement system according to claim 16, wherein prior to deletion of the transaction content, the deletion of the transaction content is reported to the transaction partner of the transaction content.

18. The online settlement system according to claim 1, wherein if there are a plurality of transaction contents, the plurality of transaction contents are grouped and payment of the plurality of transaction contents is settled at one time.

19. The online settlement system according to claim 18, wherein if an account balance of an account handling institute is not sufficient to settle payment of all the grouped transaction contents, the payment of the entire grouped transaction contents is stopped.

20. The online settlement system according to claim 1, wherein the transaction contents stored in said transaction content storage unit are generated and stored when the user applies for a transaction, and both display of a list of transaction contents, the price payment of which are not settled, and payment of the prices are made after the user applies for the transaction.

21. The online settlement system according to claim 1, wherein if the list of transaction contents to be settled is displayed, an advertisement related to the transaction contents is presented to the user together with the list.

22. The online settlement system according to claim 1, wherein if the price is paid, account balance of an account handling institute used by the user is presented to the user.

23. The online settlement system according to claim 1, further comprising
a transaction content detailed information display unit displaying detailed information about transaction contents displayed by said unsettled payment list display unit.

24. The online settlement system according to claim 1, said transaction content detailed information display unit further comprising
a transaction target information display unit displaying information about a transaction target.

25. An online settlement method for settling payment of a transaction online, comprising:
storing a transaction content of a user;
presenting transaction contents, the price payment of which is not settled, out of the transaction contents stored in the transaction content storage unit at a request from the user; and
enabling the user to pay a price of a transaction content to be settled by the user using an account handling institute.

26. The online settlement method according to claim 25, wherein said transaction content storage step receives online a content of a transaction conducted by a user online and stores the content.

27. The online settlement method according to claim 25, wherein said transaction content storage step receives online a content of a transaction conducted by a user offline from a transaction partner of the user and stores the content.

28. The online settlement method according to claim 25, further comprising
notifying a user of a payment request if a transaction content of a user is received from the transaction partner.

29. The online settlement method according to claim 25, wherein the account handling institute can settle payment online.

30. The online settlement method according to claim 25, further comprising
deleting a settled item from a transaction content stored in said transaction content storage unit.

31. The online settlement method according to claim 30, wherein said deletion step stores a settled item in a settled transaction content storage unit.

32. The online settlement method according to claim 25, further comprising
displaying user's past payment histories at a request from the user.

33. The online settlement method according to claim 25, further comprising
displaying a list of transaction contents conducted with a transaction partner at a request from the transaction partner of a user.

34. The online settlement method according to claim 33, further comprising
displaying past payment histories of a transaction partner at a request from the transaction partner.

35. The online settlement method according to claim 25, further comprising
recommending an appropriate account handling institute to be used to the user if there are a plurality of the account handling institutes.

36. The online settlement method according to claim 25, further comprising
notifying a transaction partner of payment of a price of a transaction, which is settled by the user.

37. The online settlement method according to claim 25, said transaction content storage step further comprises
setting a payment time limit to each transaction and warning the user against the payment when the payment time limit of each transaction comes a prescribed number of days before.

38. The online settlement method according to claim 37, wherein said warning step warns a user against payment when the user is logged in this online settlement system.

39. The online settlement method according to claim 37, wherein said warning step warns a user against payment by electronic mail.

40. The online settlement method according to claim 25, wherein a payment time limit of each transaction is set in said transaction content storage step and the transaction content of each transaction is deleted when the payment time limit is expired.

41. The online settlement method according to claim 40, wherein prior to deletion of the transaction content, the deletion of the transaction content is reported to the transaction partner of the transaction content.

42. The online settlement method according to claim 25, wherein if there are a plurality of transaction contents, the plurality of transaction contents are grouped and payment of the plurality of transaction contents is settled at one time.

43. The online settlement method according to claim 42, wherein if an account balance of an account handling institute is not sufficient to settle payment of the entire grouped transaction contents, the payment of the entire grouped transaction contents is stopped.

44. The online settlement method according to claim 25, wherein the transaction contents stored in said transaction content storage unit are generated and stored when the user applies for a transaction, and both display of a list of transaction contents, the price payment of which are not settled, and payment of the prices are made after the user applies for the transaction.

45. The online settlement method according to claim 25, wherein if the list of transaction contents to be settled is displayed, an advertisement related to the transaction contents is presented to the user together with the list.

46. The online settlement method according to claim 25, wherein if the price is paid, account balance of an account handling institute used by the user is presented to the user.

47. The online settlement method according to claim 25, further comprising
displaying detailed information about transaction contents displayed by said unsettled payment list display step.

48. The online settlement method according to claim 25, said transaction content detailed information display step further comprising
displaying information about a transaction target.

49. A storage medium which stores a program for enabling a computer to implement an online settlement process for settling payment of a transaction online, said process comprising:
storing a transaction content of a user;
presenting transaction contents, the price payment of which is not settled, out of the transaction contents stored in the transaction content storage unit at a request from the user; and
enabling the user to pay a price of a transaction content to be settled by the user using an account handling institute.

50. The storage medium according to claim 49, wherein said transaction content storage step receives online a content of a transaction conducted online by a user and stores the content.

51. The storage medium according to claim 49, wherein said transaction content storage step receives online a content of a transaction conducted offline by a user from a transaction partner of the user and stores the content.

52. The storage medium according to claim 49, further comprising
notifying a user of a payment request if a transaction content of a user is received from the transaction partner.

53. The storage medium according to claim 49, wherein the account handling institute can settle a payment online.

54. The storage medium according to claim 49, further comprising
deleting a settled item from a transaction content stored in said transaction content storage unit.

55. The storage medium according to claim 54, wherein said deletion step stores a settled item in a settled transaction content storage unit.

56. The storage medium according to claim 49, further comprising
displaying user's past payment histories at a request from the user.

57. The storage medium according to claim 49, further comprising
displaying a list of transaction contents conducted with a transaction partner at a request from the transaction partner of a user.

58. The storage medium according to claim 57, further comprising
displaying past payment histories of a transaction partner at a request from the transaction partner.

59. The storage medium according to claim 49, further comprising
recommending an appropriate account handling institute to be used to the user if there are a plurality of the account handling institutes.

60. The storage medium according to claim 49, further comprising
notifying a transaction partner of payment of a price of a transaction, which is settled by the user.

61. The storage medium according to claim 49, said transaction content storage step further comprising
setting a payment time limit to each transaction and warning the user against the payment when the payment time limit of each transaction comes a prescribed number of days before.

62. The storage medium according to claim 61, wherein said warning step warns a user against payment when the user is logged in this online settlement system.

63. The storage medium according to claim 61, wherein said warning step warns a user against payment by electronic mail.

64. The storage medium according to claim 49, wherein a payment time limit of each transaction is set in said transaction content storage step and the transaction content of each transaction is deleted when the payment time limit is expired.

65. The storage medium according to claim 64, wherein prior to deletion of the transaction content, the deletion of the transaction content is reported to the transaction partner of the transaction content.

66. The storage medium according to claim 49, wherein if there are a plurality of transaction contents, the plurality of transaction contents are grouped and payment of the plurality of transaction contents is settled at one time.

67. The storage medium according to claim 66, wherein if an account balance of an account handling institute is not sufficient to settle payment of the entire grouped transaction contents, the payment of the entire grouped transaction contents is stopped.

68. The storage medium according to claim 49, wherein the transaction contents stored in said transaction content storage unit are generated and stored when the user applies for a transaction, and both display of a list of transaction contents, the price payment of which are not settled, and payment of the prices are made after the user applies for the transaction.

69. The storage medium according to claim 49, wherein if the list of transaction contents to be settled is displayed, an advertisement related to the transaction contents is presented to the user together with the list.

70. The storage medium according to claim 49, wherein if the price is paid, account balance of an account handling institute used by the user is presented to the user.

71. The storage medium according to claim 49, further comprising
displaying detailed information about transaction contents displayed by said unsettled payment list display step.

72. The storage medium according to claim 49, said transaction content detailed information display step further comprising
displaying information about a transaction target.

73. A transaction management device, comprising:
a user management unit managing both identification information about an account used to settle payment for each user and identification information about an account handling institute with the account;
a transaction information receiving unit receiving transaction information, including identification information about a first user paying for a transaction conducted on a network, identification information about a second user receiving the payment and information about a content of the transaction;
a unit obtaining both identification information about the relevant account and transaction information and the account handling institute from the identification information of the users based on both transaction information received from the receiving unit, and information managed by the user management unit; and
a transmitting unit transmitting a payment request from an account of the first user to an account of the second user, to an account handling institute with the relevant account of the first user.

74. The transaction management device according to claim 73, further comprising
a completion notification unit notifying the second user of payment completion, including both information about the first user and information about a transaction content.

75. The transaction management device according to claim 73, further comprising
a unit recommending an appropriate account to be used based on identification information about an account handling institute of the second user if said user management unit manages a plurality of the first user accounts.
